(19) United States
(12) Patent Application Publication
(10) Pub. No.: US 2025/0175012 A1
(43) Pub. Date: May 29, 2025

(54) CHARGING PROBABILITY SHARING AND CHARGING USER EQUIPMENT (UE) BEHAVIOR

(71) Applicant: QUALCOMM Incorporated, San Diego, CA (US)

(72) Inventors: Ahmed Attia ABOTABL, San Diego, CA (US); Ahmed ELSHAFIE, San Diego, CA (US); Alexandros MANOLAKOS, Athens (GR)

(21) Appl. No.: 18/726,949

(22) PCT Filed: Mar. 16, 2023
(86) PCT No.: PCT/US2023/064532

§ 371 Date: Jul. 5, 2024

(30) Foreign Application Priority Data
Mar. 28, 2022 (GR) 20220100270

(51) Int. Cl. H02J 7/00; H02J 7/34

(52) U.S. Cl. CPC H02J 7/00032; H02J 7/0048; H02J 7/007188; H02J 7/342

(57) ABSTRACT

Methods, systems, and devices for wireless communications are described. A first user equipment (UE) may receive, from a second UE, a first message indicating a request for the first UE to charge a battery of the second UE using radio frequency (RF) signaling. The first UE may transmit a second message to the second UE in response to the first message based on a charging probability associated with the request, an available power at the first UE, one or more configured thresholds, or a combination thereof. For example, the first UE may calculate the charging probability based on a likelihood of the first UE to grant or deny the request. The second message may include an indication that the request is granted or that the request is denied. In some cases, the first UE may transmit an indication of the charging probability to one or more other charging UEs.

### CROSS REFERENCES

The present application is a 371 national stage filing of International PCT Application No. PCT/US2023/064532 by ABOTABL et al. entitled “CHARGING PROBABILITY SHARING AND CHARGING USER EQUIPMENT (UE) BEHAVIOR,” filed Mar. 16, 2023; and claims priority to Greek Patent Application No. 20220100270 by ABOTABL et al., entitled “CHARGING PROBABILITY SHARING AND CHARGING USER EQUIPMENT (UE) BEHAVIOR,” filed Mar. 28, 2022, each of which is assigned to the assignee hereof, and each of which is expressly incorporated by reference in its entirety herein.

### FIELD OF TECHNOLOGY

The following relates to wireless communications, including charging probability sharing and charging user equipment (UE) behavior.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a relatively low-power device may be capable of using energy (e.g., electromagnetic energy) from a received radio frequency (RF) signal to perform operations at the device, which may be referred to as energy harvesting (EH). The EH device may “harvest” energy from the RF signal to charge a battery at the EH device or to perform select tasks (e.g., data decoding, data encoding, data transmission, data reception). The EH device may transmit a charging request message to one or more other devices, referred to as charging devices, to request an RF signal for EH. However, in some examples, charging devices may ignore such requests, potentially causing the EH device to lose power or fail to perform specific operations due to a power deficiency at the EH device.

### SUMMARY

The described techniques relate to improved methods, systems, devices, and apparatuses that support charging probability sharing and charging user equipment (UE) behavior. Generally, the described techniques provide for a charging UE (e.g., a UE capable of transmitting a charging radio frequency (RF) signal) to improve decision-making regarding granting or denying requests for charging a requesting UE (e.g., a UE capable of harvesting energy from the charging RF signal, which may be referred to as an energy harvesting (EH) UE). For example, the charging UE may receive a first message from the requesting UE indicating a request for the charging UE to charge a battery of the requesting UE via RF signaling. In some examples, the first message may be broadcast or multicast, e.g., to multiple charging UEs. The charging UE receiving the first message may grant or deny the request based on an available power at the charging UE, a charging probability related to the request (e.g., a likelihood of the charging UE to grant the request), or some combination thereof. The charging UE may transmit a second message (e.g., to the requesting UE in response to the first message) indicating that the request is granted or that the request is denied. If the charging UE grants the request, the charging UE may transmit RF signaling to the requesting UE to be used for energy harvesting.

Additionally, or alternatively, the charging UE may store information relating to the received requests for charge and respective responses (e.g., grants or denials), and the charging UE may calculate or otherwise determine a charging probability based on the stored information. The charging UE may update the charging probability over time as the charging UE receives requests for charge from requesting UEs and grants or denies the requests. In some cases, the charging UE may transmit a third message indicating the calculated charging probability to other charging UEs via broadcast, multicast, or unicast signaling, for example, periodically or upon request. The sharing of charging probability information between charging UEs may support improved logic and decision-making across a network of charging UEs when determining whether to grant or deny charging requests by requesting UEs.

A method for wireless communications at a first UE is described. The method may include receiving, from a second UE, a first message indicating a request for the first UE to charge a battery of the second UE using RF signaling and transmitting, to the second UE, a second message in response to the first message, the second message including an indication that the request is granted by the first UE or an indication that the request is denied by the first UE based on an available power at the first UE, one or more available power thresholds, a charging probability associated with the request, and a charging probability threshold.

An apparatus for wireless communications at a first UE is described. The apparatus may include a memory and a processor coupled with the memory and configured to cause the apparatus to receive, from a second UE, a first message indicating a request for the first UE to charge a battery of the second UE using RF signaling and transmit, to the second UE, a second message in response to the first message, the second message including an indication that the request is granted by the first UE or an indication that the request is denied by the first UE based on an available power at the first UE, one or more available power thresholds, a charging probability associated with the request, and a charging probability threshold.

Another apparatus for wireless communications at a first UE is described. The apparatus may include means for receiving, from a second UE, a first message indicating a request for the first UE to charge a battery of the second UE using RF signaling and means for transmitting, to the second UE, a second message in response to the first message, the second message including an indication that the request is granted by the first UE or an indication that the request is denied by the first UE based on an available power at the first UE, one or more available power thresholds, a charging probability associated with the request, and a charging probability threshold.

A non-transitory computer-readable medium storing code for wireless communications at a first UE is described. The code may include instructions executable by a processor to receive, from a second UE, a first message indicating a request for the first UE to charge a battery of the second UE using RF signaling and transmit, to the second UE, a second message in response to the first message, the second message including an indication that the request is granted by the first UE or an indication that the request is denied by the first UE based on an available power at the first UE, one or more available power thresholds, a charging probability associated with the request, and a charging probability threshold.

Some examples of the method, apparatuses, and non-transitory computer-readable medium described herein may further include operations, features, means, or instructions for comparing the charging probability to the charging probability threshold, where transmitting the second message may be based on the comparing.

Some examples of the method, apparatuses, and non-transitory computer-readable medium described herein may further include operations, features, means, or instructions for comparing the available power at the first UE to a first available power threshold and a second available power threshold of the one or more available power thresholds, where comparing the charging probability to the charging probability threshold may be based on the available power at the first UE satisfying the first available power threshold and failing to satisfy the second available power threshold.

In some examples of the method, apparatuses, and non-transitory computer-readable medium described herein, the second message includes the indication that the request is denied by the first UE based on the charging probability satisfying the charging probability threshold.

In some examples of the method, apparatuses, and non-transitory computer-readable medium described herein, the second message includes the indication that the request is granted by the first UE based on the charging probability failing to satisfy the charging probability threshold.

Some examples of the method, apparatuses, and non-transitory computer-readable medium described herein may further include operations, features, means, or instructions for comparing the available power at the first UE to a first available power threshold of the one or more available power thresholds, where the second message includes the indication that the request is denied by the first UE based on the available power at the first UE failing to satisfy the first available power threshold.

Some examples of the method, apparatuses, and non-transitory computer-readable medium described herein may further include operations, features, means, or instructions for comparing the available power at the first UE to a second available power threshold of the one or more available power thresholds, where the second message includes the indication that the request is granted by the first UE based on the available power at the first UE satisfying the second available power threshold.

Some examples of the method, apparatuses, and non-transitory computer-readable medium described herein may further include operations, features, means, or instructions for calculating the charging probability based on a set of statuses corresponding to a set of messages received from the second UE and indicating charging requests, where a status of a respective message of the set of messages indicates whether a charging request of the respective message was granted or denied.

Some examples of the method, apparatuses, and non-transitory computer-readable medium described herein may further include operations, features, means, or instructions for calculating the charging probability based on a set of statuses corresponding to a set of messages received from a set of multiple UEs and indicating charging requests, where a status of a respective message of the set of messages indicates whether a charging request of the respective message was granted or denied.

Some examples of the method, apparatuses, and non-transitory computer-readable medium described herein may further include operations, features, means, or instructions for calculating the charging probability based on a likelihood of the first UE to grant the request.

Some examples of the method, apparatuses, and non-transitory computer-readable medium described herein may further include operations, features, means, or instructions for updating the charging probability based on the second message.

Some examples of the method, apparatuses, and non-transitory computer-readable medium described herein may further include operations, features, means, or instructions for transmitting a third message indicating the charging probability.

Some examples of the method, apparatuses, and non-transitory computer-readable medium described herein may further include operations, features, means, or instructions for receiving, from a third UE, a fourth message indicating a second charging probability stored at the third UE and associated with the request and calculating the charging probability based on the second charging probability.

In some examples of the method, apparatuses, and non-transitory computer-readable medium described herein, the charging probability indicates a probability that the first UE will grant the request for the first UE to charge the battery of the second UE.

Some examples of the method, apparatuses, and non-transitory computer-readable medium described herein may further include operations, features, means, or instructions for receiving control signaling configuring the one or more available power thresholds, the charging probability threshold, or a combination thereof.

In some examples of the method, apparatuses, and non-transitory computer-readable medium described herein, the control signaling may be received from a network entity and the control signaling may include radio resource control (RRC) signaling.

Some examples of the method, apparatuses, and non-transitory computer-readable medium described herein may further include operations, features, means, or instructions for transmitting, to the second UE, an RF signal for EH based on the second message including the indication that the request is granted by the first UE.

A method for wireless communications at a first UE is described. The method may include receiving, from a second UE, a first message indicating a request for the first UE to charge a battery of the second UE using RF signaling, transmitting, to the second UE, a second message in response to the first message based on a charging probability associated with the request, the second message including an indication that the request is granted by the first UE or an indication that the request is denied by the first UE, updating the charging probability based on the second message, and transmitting, to one or more additional UEs, a third message indicating the charging probability based on the updating.

An apparatus for wireless communications at a first UE is described. The apparatus may include a memory and a processor coupled with the memory and configured to cause the apparatus to receive, from a second UE, a first message indicating a request for the first UE to charge a battery of the second UE using RF signaling, transmit, to the second UE, a second message in response to the first message based on a charging probability associated with the request, the second message including an indication that the request is granted by the first UE or an indication that the request is denied by the first UE, update the charging probability based on the second message, and transmit, to one or more additional UEs, a third message indicating the charging probability based on the updating.

Another apparatus for wireless communications at a first UE is described. The apparatus may include means for receiving, from a second UE, a first message indicating a request for the first UE to charge a battery of the second UE using RF signaling, means for transmitting, to the second UE, a second message in response to the first message based on a charging probability associated with the request, the second message including an indication that the request is granted by the first UE or an indication that the request is denied by the first UE, means for updating the charging probability based on the second message, and means for transmitting, to one or more additional UEs, a third message indicating the charging probability based on the updating.

A non-transitory computer-readable medium storing code for wireless communications at a first UE is described. The code may include instructions executable by a processor to receive, from a second UE, a first message indicating a request for the first UE to charge a battery of the second UE using RF signaling, transmit, to the second UE, a second message in response to the first message based on a charging probability associated with the request, the second message including an indication that the request is granted by the first UE or an indication that the request is denied by the first UE, update the charging probability based on the second message, and transmit, to one or more additional UEs, a third message indicating the charging probability based on the updating.

Some examples of the method, apparatuses, and non-transitory computer-readable medium described herein may further include operations, features, means, or instructions for receiving, from a third UE, a fourth message indicating a second charging probability stored at the third UE and associated with the request and calculating the charging probability based on the second charging probability.

Some examples of the method, apparatuses, and non-transitory computer-readable medium described herein may further include operations, features, means, or instructions for calculating the charging probability based on a set of statuses corresponding to a set of messages received from the second UE and indicating charging requests, where a status of a respective message of the set of messages indicates whether a charging request of the respective message was granted or denied.

Some examples of the method, apparatuses, and non-transitory computer-readable medium described herein may further include operations, features, means, or instructions for calculating the charging probability based on a set of statuses corresponding to a set of messages received from a set of multiple UEs and indicating charging requests, where a status of a respective message of the set of messages indicates whether a charging request of the respective message was granted or denied.

Some examples of the method, apparatuses, and non-transitory computer-readable medium described herein may further include operations, features, means, or instructions for calculating the charging probability based on a likelihood of the first UE to grant the request.

Some examples of the method, apparatuses, and non-transitory computer-readable medium described herein may further include operations, features, means, or instructions for updating a probability distribution for charging times based on a time duration between receiving the first message and transmitting the second message, where the third message further indicates the probability distribution.

Some examples of the method, apparatuses, and non-transitory computer-readable medium described herein may further include operations, features, means, or instructions for calculating the charging probability based on a likelihood of the first UE to grant the request within a time duration.

Some examples of the method, apparatuses, and non-transitory computer-readable medium described herein may further include operations, features, means, or instructions for storing, at the first UE, a first indication of a set of multiple requests for the first UE to charge the battery of the second UE using the RF signaling and storing, at the first UE, a second indication of a set of multiple statuses corresponding to the set of multiple requests, where a status of a respective request of the set of multiple requests indicates whether the respective request was granted or denied by the first UE, where the charging probability may be based on the first indication and the second indication.

In some examples of the method, apparatuses, and non-transitory computer-readable medium described herein, the charging probability indicates a probability that the first UE will grant the request for the first UE to charge the battery of the second UE.

In some examples of the method, apparatuses, and non-transitory computer-readable medium described herein, the third message may be transmitted according to a periodicity, a schedule, or both.

Some examples of the method, apparatuses, and non-transitory computer-readable medium described herein may further include operations, features, means, or instructions for receiving, from a third UE, a fifth message requesting sharing of the charging probability, where the third message may be transmitted in response to the fifth message and the one or more additional UEs includes at least the third UE.

In some examples of the method, apparatuses, and non-transitory computer-readable medium described herein, the third message may be transmitted via broadcast, unicast, or multicast signaling.

In some examples of the method, apparatuses, and non-transitory computer-readable medium described herein, the third message includes a physical shared channel transmission, a sidelink transmission, a medium access control (MAC) control element (CE), or a combination thereof.

### BRIEF DESCRIPTION OF THE DRAWINGS

FIGS. 1 and 2 illustrate examples of wireless communications systems that support charging probability sharing and charging user equipment (UE) behavior in accordance with aspects of the present disclosure.

FIG. 3 illustrates an example of a process flow that supports charging probability sharing and charging UE behavior in accordance with aspects of the present disclosure.

FIG. 4 illustrates an example of a charging UE behavior scheme that supports charging probability sharing and charging UE behavior in accordance with aspects of the present disclosure.

FIGS. 5A, 5B, and 5C illustrate examples of energy harvesting (EH) architectures that support charging probability sharing and charging UE behavior in accordance with aspects of the present disclosure.

FIGS. 6 and 7 show block diagrams of devices that support charging probability sharing and charging UE behavior in accordance with aspects of the present disclosure.

FIG. 8 shows a block diagram of a communications manager that supports charging probability sharing and charging UE behavior in accordance with aspects of the present disclosure.

FIG. 9 shows a diagram of a system including a device that supports charging probability sharing and charging UE behavior in accordance with aspects of the present disclosure.

FIGS. 10 through 13 show flowcharts illustrating methods that support charging probability sharing and charging UE behavior in accordance with aspects of the present disclosure.

### DETAILED DESCRIPTION

In some wireless communications systems, relatively low-power devices such as Internet of Things (IoT) devices or other user equipment (UE) devices may perform energy harvesting (EH) to supplement or achieve battery charging at the devices. For example, a device may receive a radio frequency (RF) signal and may use energy from the RF signal to charge a battery at the device or otherwise provide power for performing one or more operations at the device. An EH-capable device may, for example, harvest energy from a received RF signal to charge a battery of the device, perform data encoding, perform data decoding, perform filtering operations, transmit data, receive data, or perform some combination of these or other processes. An EH device may transmit a charging request message to one or more other devices (e.g., network devices) capable of providing energy via an RF signal, such as a network entity or a UE (e.g., which may be referred to as charging devices), where the charging request message indicates a request for a charging device to charge a battery of the EH device. A charging device receiving the charging request message may grant or deny the charging request. The charging device may transmit a response message to the requesting EH device indicating whether the charging request (i.e., the request for charge) is granted or denied. If granted, the charging device may provide charge to the EH device via RF signaling. A network with multiple EH devices and multiple charging devices may be referred to as an EH network.

In some EH networks, however, charging devices may fail to efficiently determine whether to grant or deny a given charging request. For example, an EH device may broadcast a charging request message to multiple charging devices, where each charging device may be unaware of which (if any) other charging devices may have received the charging request message or may be capable (or incapable) of granting the charging request. Additionally, if a charging device receives a relatively large quantity of charging request messages from one or more EH devices, determining whether to grant or deny each charging request may introduce significant latency. In some cases, such response delays may lead to charging requests being entirely dropped or otherwise denied. In some such cases, the requesting EH device may be left without power. Thus, failure to characterize (e.g., prioritize) and communicate charging request information amongst charging devices may contribute to denied charging requests (e.g., repeated denial of charging requests from a same EH device, potentially leading the EH device to power down), suboptimal power distribution in the EH network, and decreased user experience.

The techniques described herein support a charging device (e.g., a charging UE) determining to grant or deny a charging request received from an EH device based on an available power at the charging UE, a charging probability associated with the charging request, one or more configured thresholds (e.g., available power thresholds, charging probability thresholds), or a combination thereof. As an example, the charging UE may deny a charging request if an available power at the charging UE fails to satisfy (e.g., is less than) a first configured power threshold or may grant the charging request if the available power at the charging UE satisfies (e.g., is greater than) a second configured power threshold. Additionally or alternatively, the charging UE may calculate a charging probability for a charging request, for instance, based on a likelihood of the charging UE to grant the charging request. The charging UE may compare the charging probability to a charging probability threshold to determine whether to grant or deny the charging request.

Additionally, the described techniques support sharing of charging probabilities amongst charging devices, such that a charging device may determine to grant or deny a charging request based on charging probability information received from one or more other charging devices. For example, a first charging UE may receive a charging request from an EH device and may also receive a message from a second charging UE indicating a charging probability associated with the charging request. The charging probability may indicate that the second charging UE is likely to satisfy the charging request; accordingly, the first charging UE may deny the charging request. Such communication of charging probability information between charging UEs in a network may support optimizations relating to granting or denying specific charging requests by specific charging UEs.

In some examples, a charging device may store information relating to a charging probability over time. For example, a charging device may receive multiple charging requests from multiple EH devices and may store a status corresponding to each received charging request, where the status indicates whether a respective charging request was granted or denied. The charging device may calculate a charging probability based on a ratio of a quantity of received charging requests to a quantity of granted charging requests. The charging device may update the charging probability based on receiving additional charging requests. The charging device may track a total charging probability, one or more requesting UE-specific charging probabilities, or both.

Aspects of the disclosure are initially described in the context of wireless communications systems. Aspects of the disclosure are then discussed with reference to a process flow, a charging UE behavior scheme, and EH architectures. Aspects of the disclosure are further illustrated by and described with reference to apparatus diagrams, system diagrams, and flowcharts that relate to charging probability sharing and charging UE behavior.

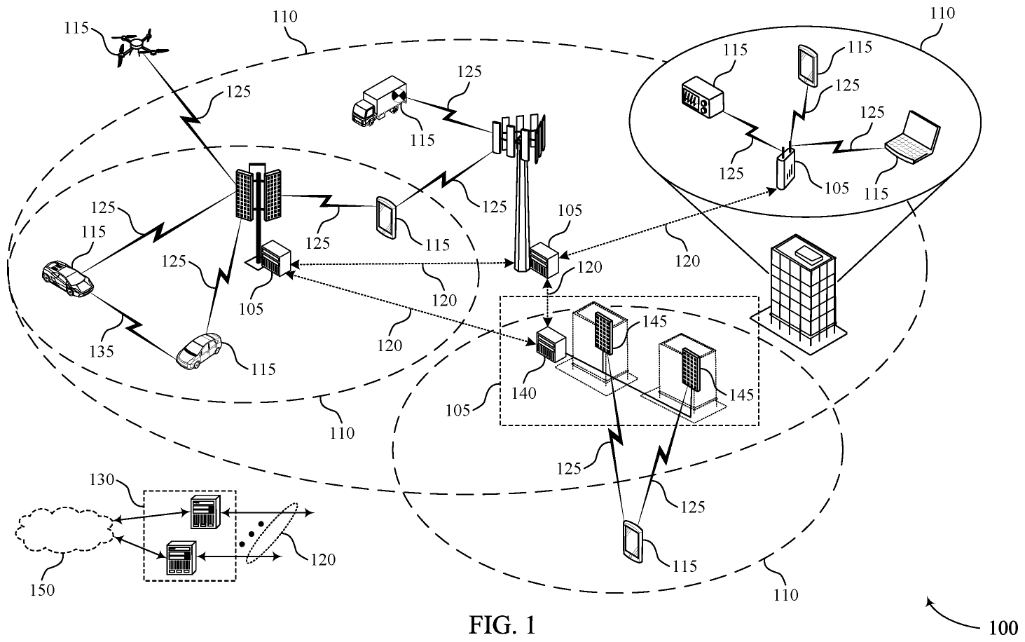

FIG. 1 illustrates an example of a wireless communications system 100 that supports charging probability sharing and charging UE behavior in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ−N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

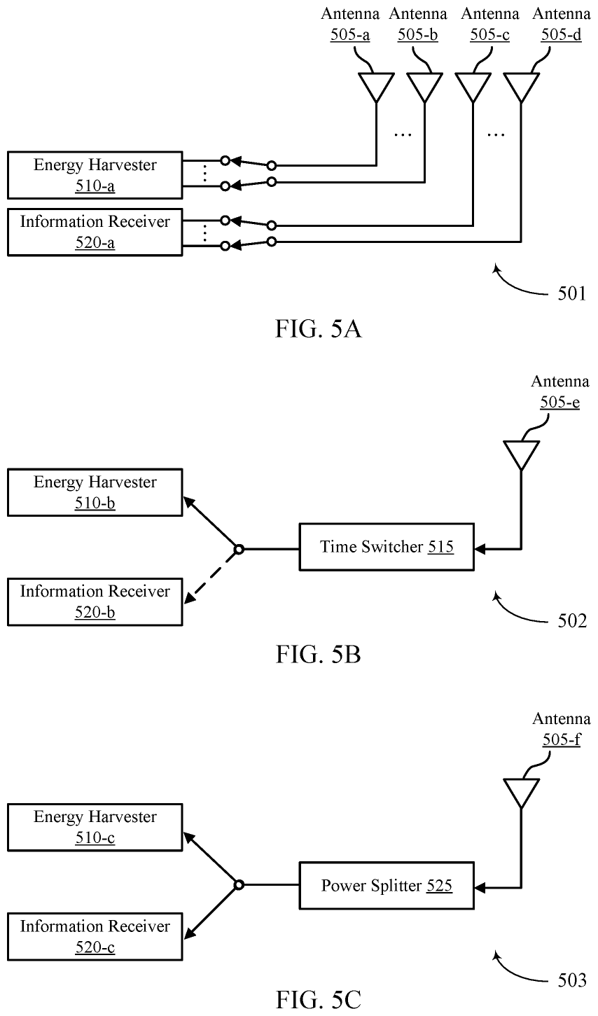

In the wireless communications system 100, a UE 115 may be an example of a low-power device, such as an IoT device, a wearable device, or the like, that is capable of harvesting energy (i.e., electromagnetic energy) from a received RF signal via EH procedures. Such devices may be referred to as EH devices or EH-capable devices. For example, the UE 115 may receive an RF signal from another device (e.g., another UE 115, a base station 105, another network entity) and may harvest energy from the RF signal to charge a battery of the UE 115, to perform some operations at the UE 115 (e.g., data reception, data transmission, encoding, decoding, filter operation), or both. The UE 115 may be configured with one or more EH architectures to support EH procedures, as described in more detail with reference to FIGS. 5A, 5B, and 5C. A network that includes multiple devices capable of performing EH operations may be referred to as an EH network. A self-sustainable network may be an example of a network (e.g., an EH network) in which a device in the network is capable of interacting with other devices in the network via energy harvested from received transmissions.

In some cases, the UE 115 may transmit a message indicating a request for another device to charge the UE 115 via an RF signal, for instance, if the UE 115 has a relatively low available power. The message indicating the request (referred to herein as a charging request message or a request for charge, among other examples) may include a binary indication (e.g., indicating whether the UE 115 is requesting power or is not requesting power) and may, in some examples, include additional information related to power at the UE 115. For instance, the message indicating the request may indicate a quantity of energy requested by the UE 115, an available power level at the UE 115, a time duration for the UE 115 to receive power before experiencing a total (or relatively significant) loss of power, a time duration that the UE 115 is able to operate at an available power level, or the like, among other examples.

A device capable of providing charge to a requesting EH device (e.g., the UE 115) may be referred to as a charging device and may be an example of another UE 115, a base station 105, or other network entities or devices. For instance, a base station 105 or other network entity may receive the message indicating the request from the UE 115 and may determine to grant the request, in which case the base station 105 or other network entity may transmit an RF signal to the UE 115 for EH purposes. The RF signal may be “empty,” in that it may not carry information or data, or may include a combination of information and signaling to be used for EH purposes. Alternatively, the base station 105 or other network entity may determine to deny the request, based on scheduling limitations or other constraints, and may refrain from transmitting the RF signal. In some cases, the base station 105 or other network entity may transmit a response message to the UE 115 indicating that the request was granted or that the request was denied.

In an EH network with many devices transmitting and receiving charging request messages and corresponding RF signals, significant latency may be introduced as charging devices determine whether to grant or deny each received charging request. For example, a charging device may receive a charging request message from multiple EH devices in an EH network in a specific time duration. The charging device may not be capable of providing charge to each requesting EH device. For instance, if the charging device is a UE 115, the charging device may have power constraints (e.g., may not have enough available power to transmit an RF signal to some or all of the requesting EH devices). Additionally or alternatively, the charging device may be unable to respond to some or all of the charging requests in a prompt manner (e.g., within a threshold time window). The charging device may have scheduling constraints, for instance, and may not be able to transmit an RF signal until after other scheduled transmissions are complete. If the number of received charging request messages is relatively large (e.g., greater than a threshold quantity), the charging device may take a considerable amount of time to determine whether to grant or deny each charging request. Additionally or alternatively, one or more charging devices may deny charging requests from the same requesting EH device, such that the EH device fails to receive an RF signal for EH purposes in a timely manner (e.g., within a threshold time). Such latency may cause power failure at a requesting EH device. For instance, a requesting EH device may fail to receive an RF signal from a charging device before powering down.

The techniques and methods described herein support more efficient prioritization and decision-making at a charging device (e.g., a UE 115, a base station 105, or another network entity) that receives a charging request message which may, in turn, reduce delay in responding to a requesting EH device. Such reduced delay may further improve the likelihood that an EH device receives an RF signal for charging before experiencing power failure. For example, a first UE 115 (i.e., a charging UE 115) may receive a message from a second UE 115 (e.g., a requesting EH device) indicating a request for the first UE 115 to charge a battery of the second UE 115 via RF signaling. The first UE 115 may grant or deny the request based on one or more configured thresholds, an available power at the first UE 115, a charging probability associated with the request, or a combination thereof.

A charging probability may represent a likelihood of a charging device to grant a received charging request. In some cases, a charging probability may be calculated for or within a time period. Additionally or alternatively, a charging probability may be associated with a charging device, an EH device, or both. For example, a charging probability associated with the first UE 115 may indicate a likelihood of the first UE 115 to grant a charging request (e.g., any charging request) and may be calculated based on a ratio of received charging requests to granted charging requests. Additionally or alternatively, a charging probability associated with the second UE 115 (e.g., the requesting UE) may indicate a likelihood that a charging request message transmitted by the second UE 115 is granted. The first UE 115 may determine a charging probability based on receiving the message indicating the charging request from the second UE 115 and may determine to grant or deny the charging request based on the charging probability.

In some examples, the first UE 115 may share the charging probability with one or more other charging devices, which may improve overall efficiency in the EH network. For instance, the first UE 115 may transmit a message indicating the charging probability to one or more other charging devices. Additionally or alternatively, the first UE 115 may receive a message from a third UE 115 (e.g., a charging UE 115) indicating a second charging probability associated with the request, for instance, associated with the second UE 115, the third UE 115, or both. If the second charging probability indicates a strong likelihood that the third UE 115 may grant the charging request for the second UE 115, the first UE 115 may determine to deny the charging request and avoid transmitting an extraneous RF signal to the second UE 115. Such a decision may reduce the power overhead at the first UE 115 and reduce the channel overhead caused by the RF signaling without negatively affecting the requesting UE 115 (e.g., if the requesting UE 115 receives an RF signal from another charging UE 115).

The first UE 115 (e.g., the charging UE 115) may transmit a response message to the second UE 115 (e.g., the requesting UE 115) including an indication that the request is denied or an indication that the request is granted. If the first UE 115 grants the request, the first UE 115 may transmit an RF signal to the second UE 115 for EH procedures at the second UE 115.

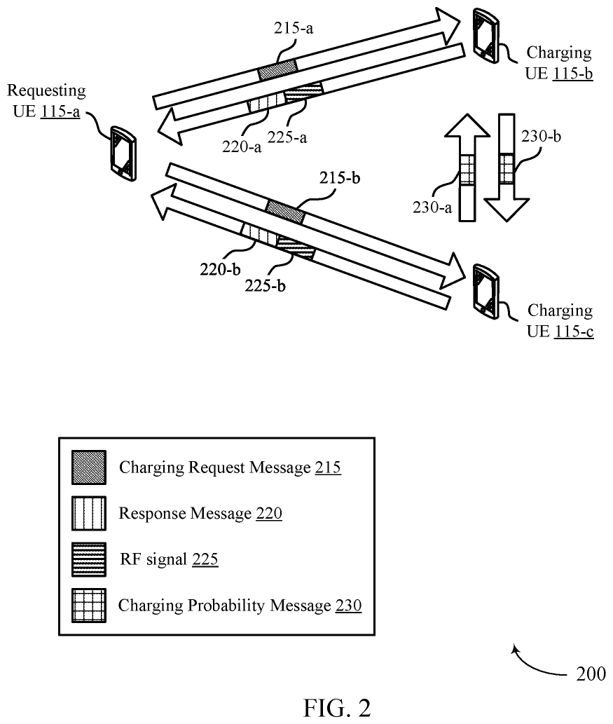

FIG. 2 illustrates an example of a wireless communications system 200 that supports charging probability sharing and charging UE behavior in accordance with aspects of the present disclosure. In some examples, the wireless communications system 200 may implement aspects of the wireless communications system 100. The wireless communications system 200 may include a requesting UE 115-a, a charging UE 115-b, and a charging UE 115-c. The requesting UE 115-a, the charging UE 115-b, and the charging UE 115-c may be examples of UEs 115 as described with reference to FIG. 1. The requesting UE 115-a may be a relatively low-power device, such as an IoT device, and may be configured with various EH architectures to facilitate performing EH procedures. That is, the requesting UE 115-a may operate using relatively small amounts of power (e.g., below a threshold), such that the requesting UE 115-a may effectively harvest energy from RF signals 225 to maintain battery life at the requesting UE 115-a without using significant channel overhead or power overhead at a charging UE 115.

The wireless communications system 200 may be an example of an EH network, in which the requesting UE 115-a may harvest energy from received transmissions to charge a battery of the requesting UE 115-a or perform specific operations. To this end, the requesting UE 115-a may transmit (e.g., via broadcast, unicast, or multicast signaling) a charging request message 215 to the charging UEs 115. The charging request message 215 may indicate a request (i.e., a charging request) for one or both of the charging UEs 115 to charge the requesting UE 115-a using RF signaling. As illustrated in FIG. 2, the requesting UE 115-a may transmit a charging request message 215-a to the charging UE 115-b and a charging request message 215-b to the charging UE 115-c.

The charging UEs 115 may grant or deny the charging request indicated in the charging request messages 215 and may transmit response messages 220 to the requesting UE 115-a. The response messages 220 may indicate that the charging request is granted or denied by the respective charging UE 115. For example, the charging UE 115-b may transmit a response message 220-a including an indication that the charging request indicated in the charging request message 215-a is granted or denied by the charging UE 115-b. Likewise, the charging UE 115-c may transmit a response message 220-b including an indication that the charging request indicated in the charging request message 215-b is granted or denied by the charging UE 115-c.

If a charging request is granted by a charging UE 115, the charging UE 115 may provide charge to the requesting UE 115-a using beamforming techniques via an RF energy signal. For example, the charging UE 115-b may transmit the RF signal 225-a to the requesting UE 115-a if the charging request indicated in the charging request message 215-a is granted. Alternatively, if the charging request is denied by the charging UE 115-b, the charging UE 115-b may not transmit the RF signal 225-a. Similarly, if the charging request indicated in the charging request message 215-b is granted by the charging UE 115-c, the charging UE 115-c may transmit the RF signal 225-b.

A charging UE 115 may determine to grant or deny a charging request in accordance with the techniques described herein. Upon receiving a charging request message 215, a charging UE 115 may grant or deny the charging request based on an available power at the charging UE 115, one or more available power thresholds, a charging probability associated with the charging request message 215, a charging probability threshold, or a combination thereof, in accordance with the techniques described herein. For example, the charging UE 115-b may determine an available power at the charging UE 115-b and may compare the available power to a first available power threshold. If the available power fails to satisfy the first available power threshold (e.g., is less than the threshold), the charging UE 115-b may not have sufficient power to charge the requesting UE 115-a and may deny the charging request by indicating the denial in the response message 220-a. Additionally or alternatively, the charging UE 115-b may compare the available power to a second available power threshold. If the available power satisfies the second available power threshold (e.g., is greater than the threshold), the charging UE 115-b may grant the charging request and may indicate the granted request in the response message 220-a. In some examples, the first and second available power thresholds may be configured via RRC signaling (e.g., received from a base station 105 or another network entity). In some other examples, the first and second available power thresholds may be pre-configured at the charging UE 115-b or may be dynamically determined by the charging UE 115-b.

Additionally or alternatively, the charging UE 115-b may grant or deny the charging request based on a charging probability associated with the charging request message 215. For instance, if the available power satisfies the first available power threshold and fails to satisfy the second available power threshold, the charging UE 115-b may determine whether to charge the requesting UE 115-a based on one or more other metrics. In some examples, the charging UE 115-b may compare the charging probability to a configured charging probability threshold. If the charging probability fails to satisfy the charging probability threshold, the charging UE 115-b may grant the charging request. Alternatively, if the charging probability satisfies the charging probability threshold, the charging UE 115-b may deny the charging request. In this way, the charging probability threshold may define a target charging probability (e.g., 80%, or some other threshold), and the charging UE 115-b may deny or grant charging requests to cause the charging probability of the charging UE 115-b to trend towards the target charging probability.

The charging UE 115-b may calculate or otherwise determine the charging probability associated with the charging request message 215 based on a quantity of received charging requests and a quantity of granted charging requests. For instance, the charging UE 115-b may store or otherwise track information related to received charging requests and respective statuses (e.g., whether a charging request was granted or denied) of the charging requests. In some cases, the charging UE 115-b may track the information over a given time period, such as a configured time period. In some examples, the charging UE 115-b may derive the charging probability based on one or more stored indications, such as a first indication of a set of charging requests and a second indication of a set of statuses corresponding to the set of charging requests. The charging probability may be calculated as a ratio of granted charging requests to received charging requests, e.g., based on the tracked information, the stored indications, or both.

Additionally, the charging probability (e.g., and the tracked information, the stored indications, or both) may be associated with a charging UE 115, a requesting UE 115, or both. For instance, the charging UE 115-b may track or store information related to a set of charging requests and respective statuses received from a specific requesting UE 115, such as the requesting UE 115-a, and may calculate a charging probability for the requesting UE 115-a based on the information. In another example, the charging UE 115-b may calculate a charging probability based on a total quantity of charging requests received at the charging UE 115-b to a total quantity of charging requests granted by the charging UE 115-b (e.g., irrespective of requesting UEs 115).

A charging probability associated with a charging UE 115 may represent a likelihood of the charging UE 115 to grant received charging requests. As a specific, non-limiting example, the charging UE 115-b may receive respective charging request messages 215 indicating a charging request from each of ten requesting UEs 115. The charging UE 115-b may grant seven of the ten charging requests, such that a charging probability of the charging UE 115-b is equal to 0.7, which may indicate a 70% likelihood that the charging UE 115-b grants a charging request.

Additionally or alternatively, a charging probability may be associated with a requesting UE 115, indicating a likelihood that a charging request transmitted by the requesting UE 115 may be granted (e.g., by any charging device). For instance, within a time period, the requesting UE 115-a may transmit a charging request message 215 to each of ten charging UEs 115; within the time period, six of the charging UEs 115 may grant a respective charging request. A charging probability of 0.6 of the requesting UE 115-a may indicate a 60% likelihood that the requesting UE 115-a is granted a charging request and receives an RF signal 225 for EH.

In some examples, a charging probability may be associated with both a charging UE 115 and a requesting UE 115. That is, a charging UE 115, such as the charging UE 115-b, may calculate a charging probability associated with a requesting UE 115, such as the requesting UE 115-a, that indicates a likelihood of the specific charging UE 115-b to grant a charging request received from the specific requesting UE 115-a. For instance, based on receiving the charging request message 215-a from the requesting UE 115-a, the charging UE 115-b may calculate a charging probability based on a ratio of a total quantity of charging request messages 215 received from the requesting UE 115-a to a quantity of granted charging requests for the requesting UE 115-a. A charging probability of 0.8 may indicate an 80% likelihood that the charging UE 115-b grants a charging request from the requesting UE 115-a.

Accordingly, a relatively high charging probability may represent a relatively high likelihood that a charging request may be granted. For instance, when the charging probability is associated with the requesting UE 115-a and fails to satisfy the charging probability threshold, the charging UE 115-b may deny the charging request because the charging request is relatively likely to be granted by another charging UE 115. As another example, a relatively high charging probability associated with the charging UE 115-b and the requesting UE 115-a may indicate a relatively high quantity of received charging requests and granted charging requests. That is, the charging UE 115-b may have frequently or recently granted a charging request for the requesting UE 115-a, and the charging UE 115-b may deny the charging request.

Put another way, if the charging UE 115-b receives multiple charging request messages 215 from requesting UEs 115, the charging UE 115-b may deprioritize charging requests from requesting UEs 115 associated with a relatively high charging probability, particularly when the charging UE 115-b has an available power level below the second available power threshold. In comparison, a relatively low charging probability may indicate that the requesting UE 115-a has been granted relatively few charging requests (by the charging UE 115-b or other charging UEs 115). Here, the charging UE 115-b may prioritize a charging request from the requesting UE 115-a to avoid power failure at the requesting UE 115-a, e.g., because the requesting UE 115-a may otherwise be unlikely to receive an RF signal 225 for energy harvesting.

In some cases, the charging UE 115-b may update a charging probability over time. For example, the charging UE 115-b may update the stored information (e.g., the one or more stored indications) as the charging UE 115-b receives charging request messages 215 and grants or denies the charging request messages 215, such that a charging probability calculated based on the stored information is also updated. In some cases, the charging UE 115-b may recalculate a charging probability upon receiving a charging request message 215, granting or denying a charging request, or both.

The charging UE 115-b may calculate a charging probability for a period of time. For instance, the charging UE 115-b may calculate a charging probability based on a likelihood of the charging UE 115-b to grant the charging request within a time duration. In some cases, the charging UE 115-b may additionally or alternatively calculate a probability distribution based on a time duration between receiving a charging request message 215 and transmitting a response message 220. The probability distribution may represent a charging time, e.g., a length of time that the requesting UE 115-a may wait before receiving a response message 220, an RF signal 225, or both in response to a charging request message 215.

The charging UE 115-b may communicate with the charging UE 115-c and other charging devices (e.g., charging UEs 115, base stations 105, other network entities) in the wireless communications system 200. For instance, the charging UE 115-b may transmit a charging probability message 230-b to the charging UE 115-c, which may include an indication of the charging probability calculated by the charging UE 115-b. In some examples, the charging UE 115-b may transmit the charging probability message 230-b based on receiving a request for sharing of the charging probability from the charging UE 115-c. Additionally or alternatively, the charging UE 115-c may transmit a charging probability message 230-a to the charging UE 115-b indicating a charging probability calculated at the charging UE 115-c. For instance, the charging UE 115-c may calculate a charging probability associated with the charging request message 215-b, e.g., associated with the charging UE 115-c, the requesting UE 115-a, or both.

The charging probability messages 230 may additionally or alternatively include an indication of the charging probability within a period of time, a probability distribution, or both. For instance, the charging UE 115-b may calculate a charging probability for a time duration and may indicate the charging probability and, in some cases, the time duration in the charging probability message 230-b. In some cases, the charging probability message 230 may indicate the probability distribution associated with the charging probability. In some examples, the charging UE 115-b and the charging UE 115-c may transmit the charging probability messages 230 via broadcast, unicast, or multicast signaling, periodically or aperiodically (e.g., based on a schedule or upon request). For instance, the charging probability messages 230 may be physical shared channel transmissions, sidelink transmissions, MAC-CEs, or some combination thereof. In some cases, the charging UE 115-b and the charging UE 115-c may broadcast or multicast the charging probability messages 230 to other charging devices in an EH network.

In some cases, a charging UE 115 may calculate or update a charging probability based on receiving a charging probability message 230. The charging UE 115-b may, for example, calculate or update a charging probability associated with the charging request message 215-a based on receiving the charging probability message 230-a, in addition to or instead of calculating a charging probability based on stored information at the charging UE 115-b.

Sharing charging probability information (e.g., via charging probability messages 230) may enable the charging UEs 115 to respond more efficiently to charging request messages 215. The charging UEs 115 may obtain knowledge of other charging UEs 115 and how likely another charging UE 115 is to grant a charging request for a requesting UE 115. For instance, if the charging probability message 230-a indicates a relatively high charging probability (e.g., the charging UE 115-c is relatively likely to grant the charging request indicated in the charging request message 215-b), the charging UE 115-b may deny the charging request indicated in the charging request message 215-a, as the requesting UE 115-a may be likely to receive an RF signal 225-b from the charging UE 115-c and may not be in danger of losing power.

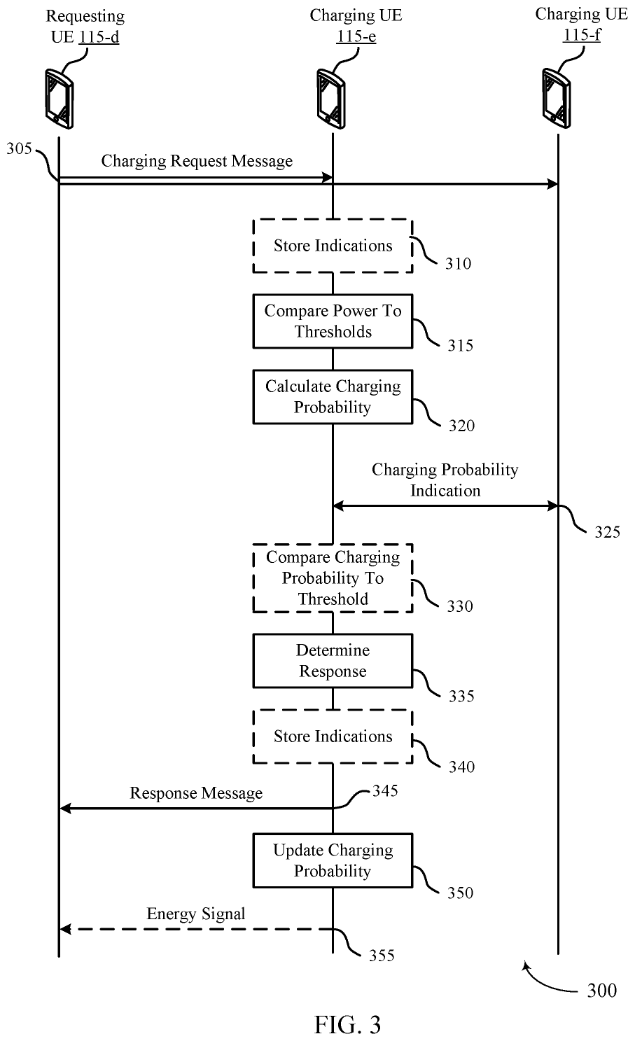

FIG. 3 illustrates an example of a process flow 300 that supports charging probability sharing and charging UE behavior in accordance with aspects of the present disclosure. In some examples, the process flow 300 may implement aspects of wireless communications systems 100 and 200. For example, the process flow 300 includes a requesting UE 115-d, a charging UE 115-e, and a charging UE 115-f, which may be examples of the corresponding devices described herein. Additionally, the operations in the process flow 300 performed by the requesting UE 115-d, the charging UE 115-e, and the charging UE 115-f may be respectively performed by a UE 115, a base station 105 (e.g., or another network entity), or another wireless device, and the example shown should not be construed as limiting.

In the process flow 300, the requesting UE 115-d may be an example of a low-power device, such as an IoT device, capable of performing EH procedures to receive charge from other network devices via RF signaling. The charging UEs 115-e and 115-f may be examples of charging devices capable of transmitting RF signaling to the requesting UE 115-d for EH procedures.

At 305, the requesting UE 115-d may transmit, and the charging UE 115-e and the charging UE 115-f may receive, signaling indicating a charging request. The signaling may be a first message that indicates a request for the charging UE 115-e, the charging UE 115-f, or both to charge a battery of the requesting UE 115-d via RF signaling. The requesting UE 115-d may transmit the first message via broadcast, unicast, or multicast signaling.

At 310, the charging UE 115-e may optionally store one or more indications related to receiving the first message at 305. For example, the charging UE 115-e may store a first indication of a set of requests (i.e., charging requests) and a second indication of a set of statuses corresponding to the set of requests. A status of a respective request may indicate whether the respective request was granted or denied by the charging UE 115-e. In some cases, the set of requests may correspond to a set of messages received from the requesting UE 115-d, while in other cases, the set of requests may correspond to a set of messages received from multiple UEs 115. The set of requests may be associated with a time period (e.g., may be received within a time period).

At 315, the charging UE 115-e may compare a power availability at the charging UE 115-e with one or more available power thresholds. For instance, the charging UE 115-e may compare an available power at the charging UE 115-e with a first available power threshold, a second available power threshold, or both. If the available power at the charging UE 115-e fails to satisfy the first available power threshold, the charging UE 115-e may not have sufficient available power to grant the charging request. If the available power at the charging UE 115-e satisfies a second available power threshold, the charging UE 115-e may have sufficient available power to grant the charging request. However, if the available power at the charging UE 115-e satisfies the first available power threshold but fails to satisfy the second available power threshold, the charging UE 115-e may determine to grant or deny the charging request based on other parameters, such as a charging probability calculated at 320, a charging probability threshold comparison at 330, or the like. In some cases, the one or more available power thresholds may be based on control signaling (e.g., RRC signaling) received (e.g., from a base station 105 or another network entity) at the charging UE 115-e, where the control signaling configures the one or more available power thresholds.

At 320, the charging UE 115-e may calculate a charging probability associated with the charging request (e.g., the first message received at 305) based on a likelihood of the charging UE 115-e to grant or deny the charging request from the requesting UE 115-d. In some cases, the charging probability may be based on a likelihood of the charging UE 115-e to grant or deny the charging request within a time duration. In some examples, the charging probability may be associated with the charging UE 115-e, the requesting UE 115-d, or both. For example, the charging UE 115-e may calculate the charging probability based on a set of statuses corresponding to a set of messages received from the requesting UE 115-d and indicating charging requests, or a set of statuses corresponding to a set of messages received from multiple UEs 115 and indicating charging requests; a status of a respective message may indicate whether a charging request of the respective message was granted or denied. In cases where the charging UE 115-e stores the first indication and the second indication at 310, the charging UE 115-e may calculate the charging probability based on the first indication and the second indication.

In some examples, at 320, the charging UE 115-e may calculate a probability distribution for charging times (e.g., a length of time before the charging UE 115-e is able to satisfy the charging request). The probability distribution may be based on a time duration between receiving the first message at 305 and transmitting a response message to the requesting UE 115-d. For instance, the charging UE 115-e may calculate a parameter (e.g., a numeric value) characterizing the probability distribution of a charging time with respect to the charging request transmitted from the requesting UE 115-d.

At 325, the charging UE 115-e may transmit and/or receive one or more messages related to the charging probability associated with the charging request. For instance, the charging UE 115-e and the charging UE 115-f may exchange signaling indicating respective charging probabilities. That is, the charging UE 115-e may transmit a message to the charging UE 115-f (e.g., and one or more other charging UEs 115) indicating the charging probability calculated at 320. The charging UE 115-e may, in some examples, receive a message from the charging UE 115-f indicating a charging probability calculated at the charging UE 115-f, which may be based on a likelihood of the charging UE 115-f to grant the charging request received at 305. In some examples, the charging UE 115-f, the charging UE 115-e, or both may indicate the charging probability within a time duration, e.g., a likelihood that the respective charging UE 115 may grant a charging request in the time duration. In some cases, the messages transmitted at 325 may indicate a probability distribution; for instance, the charging UE 115-e may indicate the probability distribution calculated at 320. In some examples, the charging UE 115-e may calculate or recalculate the charging probability based on a charging probability received from the charging UE 115-f.

In some examples, the charging UE 115-e may transmit the message indicating the charging probability at 325 based on receiving a request message from the charging UE 115-f. For instance, the charging UE 115-f may transmit a message to the charging UE 115-e requesting sharing of the charging probability, and the charging UE 115-e may transmit the message indicating the charging probability in response. In some cases, the charging UE 115-e may transmit the message indicating the charging probability to multiple charging UEs 115, e.g., via broadcast, unicast, or multicast signaling, and according to a periodicity, a schedule, or both.

A message indicating the charging probability transmitted at 325 may be a physical shared channel transmission, a sidelink transmission, a MAC-CE, or some combination thereof. For instance, the charging UE 115-e and the charging UE 115-f may operate in a sidelink communications system such that the charging UE 115-e transmits a sidelink message to the charging UE 115-f at 325. Alternatively, the charging UE 115-f may be an example of a base station or a network node (e.g., any network entity), and the charging UE 115-e may transmit a physical shared channel transmission (e.g., a PUSCH transmission) at 325 to share charging probability information with the base station or network node (e.g., any network entity).

At 330, the charging UE 115-e may compare the charging probability (e.g., calculated at 320) to a charging probability threshold, for example, based on the available power threshold comparison at 315. For instance, at 315, the charging UE 115-e may determine that the available power at the charging UE 115-e satisfies the first available power threshold but fails to satisfy the second available power threshold. Accordingly, the charging UE 115-e may compare the charging probability calculated at 320 to a charging probability threshold to determine whether to grant or deny the charging request. A relatively high charging probability threshold may indicate a strong likelihood that the charging request will be granted (e.g., by the charging UE 115-e, the charging UE 115-f, or another charging device). As such, if the charging probability fails to satisfy the charging probability threshold, the charging UE 115-e may determine to grant the charging request to avoid power failure at the requesting UE 115-d. Alternatively, if the charging probability satisfies the charging probability threshold, the charging UE 115-e may determine to deny the charging request (e.g., to conserve power at the charging UE 115-e). In some cases, the charging probability threshold may be based on control signaling (e.g., RRC signaling) received (e.g., from a base station 105 or another network entity) at the charging UE 115-e, where the control signaling configures the charging probability threshold.

At 335, the charging UE 115-e may determine a response to the charging request (i.e., the first message received at 305). That is, the charging UE 115-e may determine to grant or deny the charge request received from the requesting UE 115-d based on the power availability at the charging UE 115-e (e.g., based on the available power threshold comparison at 315), the charging probability calculated at 320, the charging probability threshold comparison at 330, or some combination thereof. For example, if the available power at the charging UE 115-e failed to satisfy the first available power threshold, the charging UE 115-e may determine to deny the charging request. Alternatively, if the available power at the charging UE 115-e satisfied the second available power threshold, the charging UE 115-e may determine to grant the charging request. If the charging UE 115-e compared the charging probability to a charging probability threshold at 330, the charging UE 115-e may determine to grant or deny the charging request based on the comparison.

In some examples, the charging UE 115-e may determine to grant or deny the charging request based on the charging probability signaling exchanged at 325. For instance, if, at 325, the charging UE 115-f indicated a charging probability associated with a relatively high likelihood that the charging UE 115-f may grant the charging request, the charging UE 115-e may, at 335, determine to deny the charging request. As another example, if the charging UE 115-f indicated a probability distribution associated with a relatively long charging time, the charging UE 115-e may determine to grant the charging request (e.g., to reduce the latency associated with charging the requesting UE 115-d).

At 340, the charging UE 115-e may optionally store one or more indications related to the charging request (i.e., the first message received at 305), a status of the charging request based on the response determined at 335, or both. In some examples, the charging UE 115-e may update the one or more indications stored at 310.

At 345, the charging UE 115-e may transmit, and the requesting UE 115-d may receive, a second message indicating the response determined at 335. The second message may be transmitted in response to receiving the charging request (i.e., the first message) at 305 and may include an indication that the charging request is granted by the charging UE 115-e or an indication that the charging request is denied by the charging UE 115-e, e.g., based on the determination at 335.

As a specific example, the charging UE 115-e may transmit the second message including an indication that the charging request is denied based on the charging probability satisfying the charging probability threshold (as determined at 330), based on the available power at the charging UE 115-e failing to satisfy the first available power threshold (as determined at 315), or some combination thereof. Alternatively, the charging UE 115-e may transmit the second message including an indication that the charging request is granted based on the charging probability failing to satisfy the charging probability threshold, based on the available power at the charging UE 115-e satisfying the second available power threshold, or some combination thereof.

At 350, the charging UE 115-e may update the charging probability based on the second message transmitted at 345. For instance, the charging UE 115-e may update the charging probability based on the indication(s) stored at 335 and/or the indication(s) stored at 310. Similarly, the charging UE 115-e may update the probability distribution for charging times based on the time duration between receiving the charging request (i.e. the first message received at 305) and transmitting the second message at 345.

If, at 345, the charging UE 115-e transmitted the second message including the indication that the charging request was granted, the charging UE 115-e may transmit, and the requesting UE 115-d may receive, an RF signal for energy harvesting at 355.

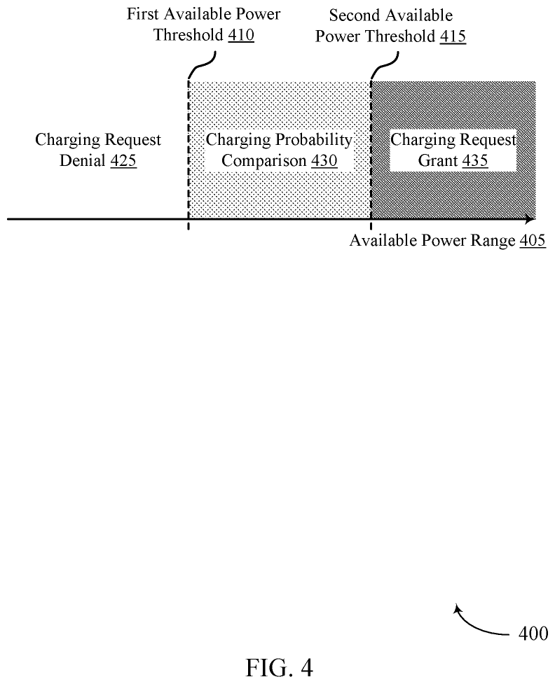

FIG. 4 illustrates an example of a charging UE behavior scheme 400 that supports charging probability sharing and charging UE behavior in accordance with aspects of the present disclosure. The charging UE behavior scheme 400 may implement or be implemented to realize aspects of the wireless communications system 100 or the wireless communications system 200. For example, the charging UE behavior scheme 400 illustrates a procedure by which a charging UE may grant or deny a charge request received from an EH device in accordance with the techniques described herein, including with reference to FIGS. 1 through 3. In some examples, the charging UE may be configured with one or more aspects of the charging UE behavior scheme 400. For instance, the charging UE may receive (e.g., from a network entity, such as a base station) control signaling (e.g., RRC signaling) configuring a first available power threshold 410 and a second available power threshold 415 with respect to an available power range 405. Additionally or alternatively, the charging UE may receive control signaling (e.g., RRC signaling) configuring a charging probability threshold.

A charging UE may receive, from an EH device, a message indicating a request for the charging UE to charge the EH device (e.g., charge a battery of the EH device) using RF signaling, as described with reference to FIGS. 2 and 3. The charging UE may implement the charging UE behavior scheme 400 to determine to grant the charging request or to deny the charging request and may transmit a response message to the EH device accordingly. For example, the charging UE may grant or deny the charging request based on one or more configured thresholds, such as the first available power threshold 410, the second available power threshold 415, or a charging probability threshold. The charging UE may use one or more additional or alternative thresholds for determining whether to grant a charging request.

The charging UE may identify an available power at the charging UE and may compare the available power to a first available power threshold 410. The first available power threshold 410 may be less than the second available power threshold 415 in the available power range 405. If the available power at the charging UE does not satisfy the first available power threshold 410, the charging UE may deny the charging request. Here, the charging UE may not have sufficient available power (e.g., above a threshold) to provide an RF signal to the EH device and may conserve power by denying the charging request. Accordingly, the charging UE may transmit a message to the EH device in response to the charging request. For example, if the available power at the charging UE fails to satisfy the first available power threshold 410, the charging UE may respond to the charging request message by indicating a charging request denial 425.

Additionally or alternatively, the charging UE may compare the available power to the second available power threshold 415. If the available power satisfies the second available power threshold 415, the charging UE may respond to the charging request message by indicating a charging request grant 435. The second available power threshold 415 may indicate an available power level at which the charging UE has sufficient available power to charge an EH device without negatively impacting performance at the charging UE.

If the available power satisfies the first available power threshold 410 but fails to satisfy the second available power threshold 415, the charging UE may perform a charging probability comparison 430. Here, the charging UE may calculate a charging probability associated with the charging request as described with reference to FIGS. 2 and 3. The charging probability may be associated with the charging UE, the EH device, or both. In the charging probability comparison 430, the charging UE may compare the charging probability to a charging probability threshold. The charging probability threshold may indicate a charging probability value associated with a relatively high likelihood that the charging request is granted. If the charging probability satisfies the charging probability threshold, the charging request may be relatively likely to be granted; as such, the charging UE may indicate that the charging request is denied. If the charging probability fails to satisfy the charging probability threshold, the charging UE may indicate that the charging request is granted.

As a specific example, the charging UE may be configured with a charging probability threshold of 0.8 and may calculate a current charging probability of 0.7 associated with the charging request. When the charging probability is associated with the charging UE, a charging probability of 0.7 may indicate that the charging UE grants 70% of received charging requests, e.g., from the EH device or other EH devices. A charging probability of 0.7 associated with the EH device may indicate that 70% of charging requests transmitted by the EH device are granted, e.g., from the charging UE or other charging devices. In either case, the EH device may be relatively less likely to be granted a charging request (e.g., than the 80% likelihood indicated by the charging probability threshold). Because the charging probability fails to satisfy the charging probability threshold, the charging UE may grant the charging request to avoid power failure at the EH device. The charging UE may transmit the response message to the EH device indicating that the charging request is granted and may subsequently transmit an RF signal to the EH device for energy harvesting.

FIGS. 5A, 5B, and 5C illustrate examples of EH architectures 501, 502, and 503, respectively, that support charging probability sharing and charging UE behavior in accordance with aspects of the present disclosure. The EH architectures 501, 502, and 503 may implement or be implemented to realize aspects of the wireless communications system 100 or the wireless communications system 200. For example, an EH device may be configured with one or more of the EH architectures 501, 502, and 503 to support EH procedures, as described with reference to FIGS. 1 through 3. The EH architectures 501, 502, and 503 may include RF components to enable the EH device to harvest energy from an RF signal and, in some cases, receive data transmissions.

In accordance with the techniques described herein, the EH device may transmit a message to a charging device indicating a request for the charging device to charge a battery of the EH device. If the charging device grants the request (e.g., as described with reference to FIGS. 2 through 4), the charging device may transmit a message to the EH device indicating that the request is granted. The charging device may transmit an RF signal for energy harvesting to the EH device; the EH device may receive the RF signal via one or more antennas and may harvest energy (e.g., electromagnetic energy) from the RF signal using an energy harvester. Additionally, the EH device may receive data transmissions via one or more of the antennas and may process the data transmissions via an information receiver. Variations across the EH architectures 501, 502, and 503 may support different techniques for energy harvesting, for instance, based on components included in the respective EH architectures 501, 502, and 503.

FIG. 5A illustrates an EH architecture 501 that may be an example of a separated receiver architecture, which may include a set of antennas, an energy harvester 510-a, and an information receiver 520-a. An EH device configured with a separated receiver architecture may perform operations for energy harvesting and information reception concurrently. That is, antennas configured for energy harvesting may be spatially separated from antennas configured for information reception, such that the EH device may receive RF signals for energy harvesting and RF signals carrying information (e.g., data transmissions) in a same time resource, a same frequency resource, or both. As illustrated, the EH device may receive RF signaling for energy harvesting via an antenna 505-a and an antenna 505-b. RF signals received via the antennas 505-a and 505-b may be processed via the energy harvester 510-a, such that the EH device may use the harvested energy to charge a battery of the EH device and/or perform other operations. Additionally, the EH device may receive data transmissions via an antenna 505-c and an antenna 505-d; data transmissions may be processed (e.g., decoded, demodulated) via the information receiver 520-a.

FIG. 5B illustrates an EH architecture 502 that may be an example of a time-switching architecture, in which the EH device may perform energy harvesting and information reception using different time resources. For example, the time-switching architecture may include an antenna 505-e, a time switcher 515, an energy harvester 510-b, and an information receiver 520-b. The time switcher 515 may enable the EH device to switch between processing a received RF signal for energy harvesting and processing a received RF signal for information reception. As illustrated, the EH device may receive an RF signal via the antenna 505-e and may switch between the energy harvester 510-b and the information receiver 520-b during different time resources (e.g., symbols, slots) using the time switcher 515.

The EH device may use the energy harvester 510-b or the information receiver 520-b based on a content of the RF signal, a designated symbol period, a time duration allocated for energy harvesting, or a combination thereof. For example, if the EH device receives an RF signal for energy harvesting (e.g., in response to a charging request message) via the antenna 505-e, the EH device may use the time switcher 515 to switch to the energy harvester 510-b. Alternatively, if the EH device receives a data transmission (e.g., a message indicating that the charging request is granted or that the charging request is denied, as described herein), the EH may use the time switcher 515 to switch to the information receiver 520-b.

Additionally or alternatively, the RF signal may be configured with a first set of symbols designated for energy harvesting and a second set of symbols designated for information reception, and the EH device may switch to the appropriate component based on the sets of symbols. As another example, the EH device may be configured with a time duration allocated for energy harvesting; the EH device may use the energy harvester 510-b during the time duration and may switch to the information receiver 520-b outside of the time duration.

FIG. 5C illustrates an EH architecture 503 that may be an example of a power-switching architecture, in which the EH device may perform operations for energy harvesting and information reception by splitting power resources. For example, the EH device may receive an RF signal at an antenna 505-f which may be connected to a power splitter 525. The power splitter 525 may split the received RF signal into two streams, where a first stream is for an energy harvester 510-c and a second stream is for an information receiver 520-c. Accordingly, the EH device may receive an RF signal for both energy harvesting and information reception, where the power splitter 525 allocates power to the energy harvester 510-c and the information receiver 520-c based on designated power proportions. The EH device may be configured to allocate a percentage of power to harvesting energy, which may also be referred to as a charging rate. As a specific example, the power splitter 525 may allocate eighty percent power to the energy harvester 510-c for energy harvesting operations and the remaining twenty percent of power to the information receiver 520-c for information reception operations.

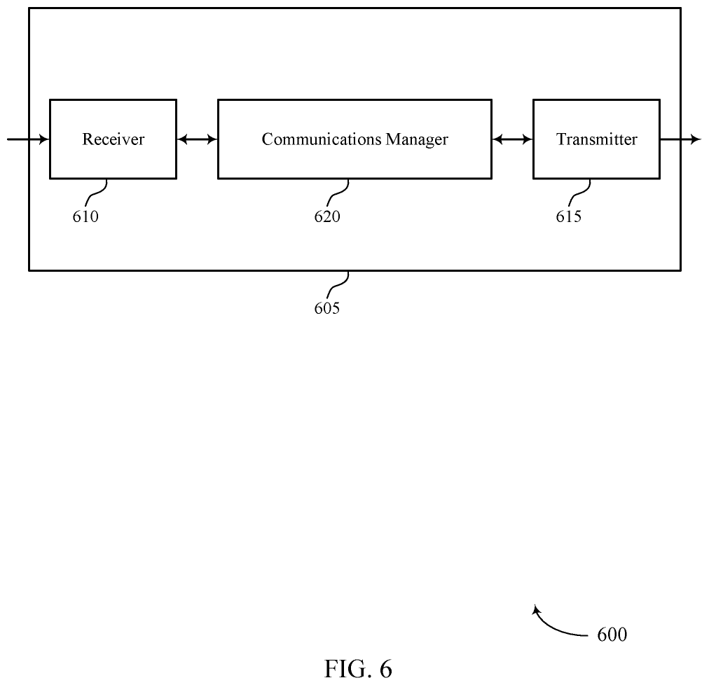

FIG. 6 shows a block diagram 600 of a device 605 that supports charging probability sharing and charging UE behavior in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to charging probability sharing and charging UE behavior). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to charging probability sharing and charging UE behavior). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of charging probability sharing and charging UE behavior as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a first UE in accordance with examples as disclosed herein. For example, the communications manager 620 may be configured as or otherwise support a means for receiving, from a second UE, a first message indicating a request for the first UE to charge a battery of the second UE using RF signaling. The communications manager 620 may be configured as or otherwise support a means for transmitting, to the second UE, a second message in response to the first message, the second message including an indication that the request is granted by the first UE or an indication that the request is denied by the first UE based on an available power at the first UE, one or more available power thresholds, a charging probability associated with the request, and a charging probability threshold.

Additionally or alternatively, the communications manager 620 may support wireless communications at a first UE in accordance with examples as disclosed herein. For example, the communications manager 620 may be configured as or otherwise support a means for receiving, from a second UE, a first message indicating a request for the first UE to charge a battery of the second UE using RF signaling. The communications manager 620 may be configured as or otherwise support a means for transmitting, to the second UE, a second message in response to the first message based on a charging probability associated with the request, the second message including an indication that the request is granted by the first UE or an indication that the request is denied by the first UE. The communications manager 620 may be configured as or otherwise support a means for updating the charging probability based on the second message. The communications manager 620 may be configured as or otherwise support a means for transmitting, to one or more additional UEs, a third message indicating the charging probability based on the updating.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for improved EH procedures. For example, the device 605 may more efficiently respond to charging requests received from EH devices based on charging probabilities associated with the charging requests, which may reduce processing and power consumption at the device 605. Additionally, increased efficiency in responding to charging requests may reduce latency for an EH device to receive a charging RF signal, thereby avoiding power failure at the EH device and improving user experience.

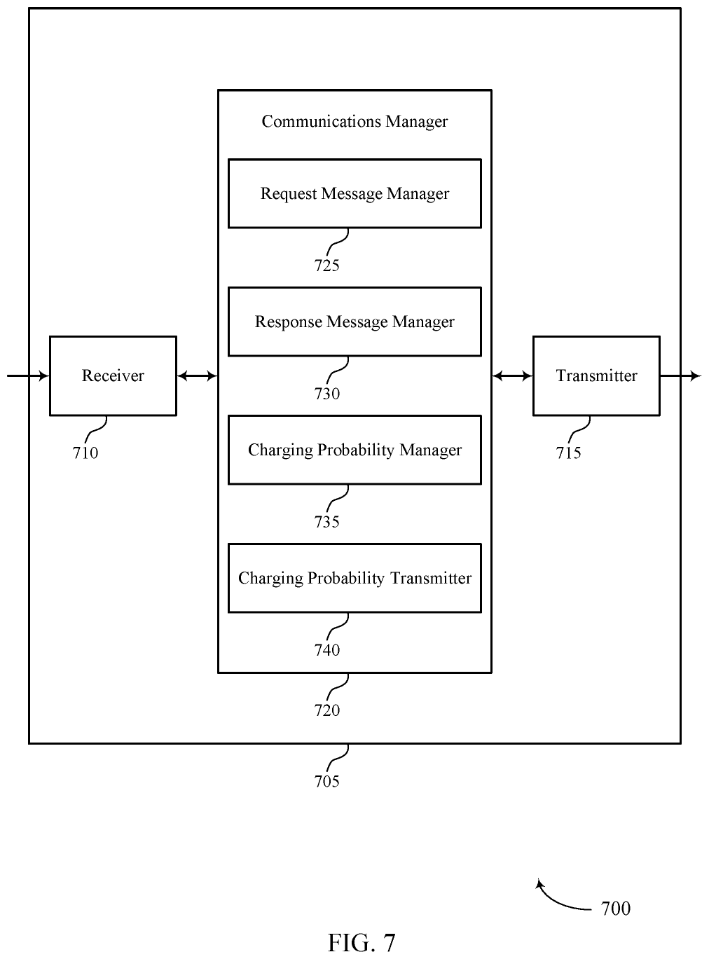

FIG. 7 shows a block diagram 700 of a device 705 that supports charging probability sharing and charging UE behavior in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to charging probability sharing and charging UE behavior). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to charging probability sharing and charging UE behavior). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of charging probability sharing and charging UE behavior as described herein. For example, the communications manager 720 may include a request message manager 725, a response message manager 730, a charging probability manager 735, a charging probability transmitter 740, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a first UE in accordance with examples as disclosed herein. The request message manager 725 may be configured as or otherwise support a means for receiving, from a second UE, a first message indicating a request for the first UE to charge a battery of the second UE using RF signaling. The response message manager 730 may be configured as or otherwise support a means for transmitting, to the second UE, a second message in response to the first message, the second message including an indication that the request is granted by the first UE or an indication that the request is denied by the first UE based on an available power at the first UE, one or more available power thresholds, a charging probability associated with the request, and a charging probability threshold.

Additionally or alternatively, the communications manager 720 may support wireless communications at a first UE in accordance with examples as disclosed herein. The request message manager 725 may be configured as or otherwise support a means for receiving, from a second UE, a first message indicating a request for the first UE to charge a battery of the second UE using RF signaling. The response message manager 730 may be configured as or otherwise support a means for transmitting, to the second UE, a second message in response to the first message based on a charging probability associated with the request, the second message including an indication that the request is granted by the first UE or an indication that the request is denied by the first UE. The charging probability manager 735 may be configured as or otherwise support a means for updating the charging probability based on the second message. The charging probability transmitter 740 may be configured as or otherwise support a means for transmitting, to one or more additional UEs, a third message indicating the charging probability based on the updating.

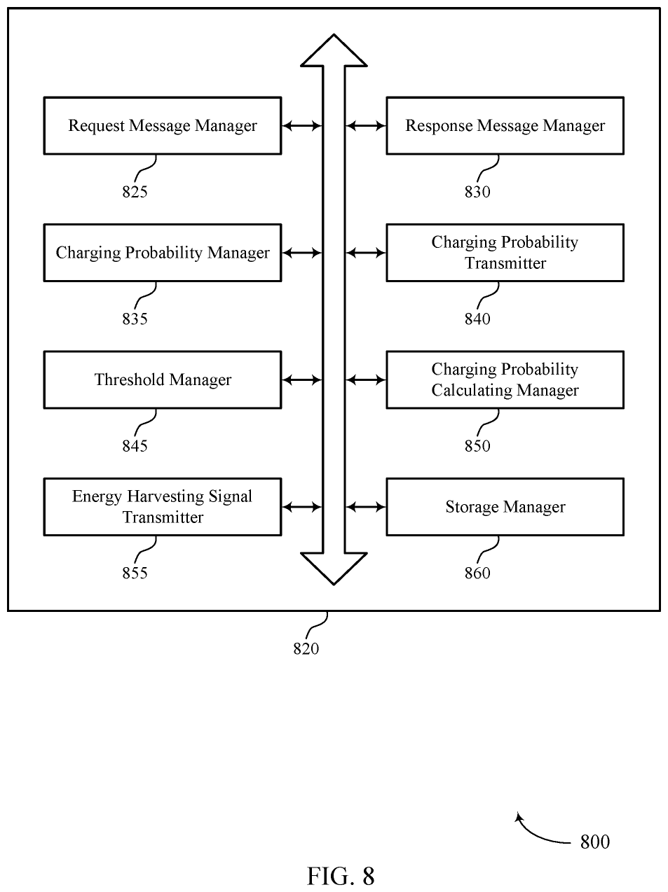

FIG. 8 shows a block diagram 800 of a communications manager 820 that supports charging probability sharing and charging UE behavior in accordance with aspects of the present disclosure. The communications manager 820 may be an example of aspects of a communications manager 620, a communications manager 720, or both, as described herein. The communications manager 820, or various components thereof, may be an example of means for performing various aspects of charging probability sharing and charging UE behavior as described herein. For example, the communications manager 820 may include a request message manager 825, a response message manager 830, a charging probability manager 835, a charging probability transmitter 840, a threshold manager 845, a charging probability calculating manager 850, an energy harvesting signal transmitter 855, a storage manager 860, or any combination thereof. Each of these components may communicate, directly or indirectly, with one another (e.g., via one or more buses).

The communications manager 820 may support wireless communications at a first UE in accordance with examples as disclosed herein. The request message manager 825 may be configured as or otherwise support a means for receiving, from a second UE, a first message indicating a request for the first UE to charge a battery of the second UE using RF signaling. The response message manager 830 may be configured as or otherwise support a means for transmitting, to the second UE, a second message in response to the first message, the second message including an indication that the request is granted by the first UE or an indication that the request is denied by the first UE based on an available power at the first UE, one or more available power thresholds, a charging probability associated with the request, and a charging probability threshold.

In some examples, the threshold manager 845 may be configured as or otherwise support a means for comparing the charging probability to the charging probability threshold, where transmitting the second message is based on the comparing.

In some examples, the threshold manager 845 may be configured as or otherwise support a means for comparing the available power at the first UE to a first available power threshold and a second available power threshold of the one or more available power thresholds, where comparing the charging probability to the charging probability threshold is based on the available power at the first UE satisfying the first available power threshold and failing to satisfy the second available power threshold.

In some examples, the second message includes the indication that the request is denied by the first UE based on the charging probability satisfying the charging probability threshold.

In some examples, the second message includes the indication that the request is granted by the first UE based on the charging probability failing to satisfy the charging probability threshold.

In some examples, the threshold manager 845 may be configured as or otherwise support a means for comparing the available power at the first UE to a first available power threshold of the one or more available power thresholds, where the second message includes the indication that the request is denied by the first UE based on the available power at the first UE failing to satisfy the first available power threshold.

In some examples, the threshold manager 845 may be configured as or otherwise support a means for comparing the available power at the first UE to a second available power threshold of the one or more available power thresholds, where the second message includes the indication that the request is granted by the first UE based on the available power at the first UE satisfying the second available power threshold.

In some examples, the charging probability calculating manager 850 may be configured as or otherwise support a means for calculating the charging probability based on a set of statuses corresponding to a set of messages received from the second UE and indicating charging requests, where a status of a respective message of the set of messages indicates whether a charging request of the respective message was granted or denied.

In some examples, the charging probability calculating manager 850 may be configured as or otherwise support a means for calculating the charging probability based on a set of statuses corresponding to a set of messages received from a set of multiple UEs and indicating charging requests, where a status of a respective message of the set of messages indicates whether a charging request of the respective message was granted or denied. In some examples, the charging probability calculating manager 850 may be configured as or otherwise support a means for calculating the charging probability based on a likelihood of the first UE to grant the request.

In some examples, the charging probability manager 835 may be configured as or otherwise support a means for updating the charging probability based on the second message.

In some examples, the charging probability transmitter 840 may be configured as or otherwise support a means for transmitting a third message indicating the charging probability.

In some examples, the charging probability manager 835 may be configured as or otherwise support a means for receiving, from a third UE, a fourth message indicating a second charging probability stored at the third UE and associated with the request. In some examples, the charging probability calculating manager 850 may be configured as or otherwise support a means for calculating the charging probability based on the second charging probability.

In some examples, the charging probability may indicate a probability that the first UE will grant the request for the first UE to charge the battery of the second UE. For example, the charging probability may be a percentage or other metric indicating the likelihood that the first UE will transmit RF signaling to the second UE for EH procedures in response to the request.

In some examples, the threshold manager 845 may be configured as or otherwise support a means for receiving control signaling configuring the one or more available power thresholds, the charging probability threshold, or a combination thereof. In some examples, the control signaling is received from a network entity and the control signaling includes RRC signaling.

In some examples, the energy harvesting signal transmitter 855 may be configured as or otherwise support a means for transmitting, to the second UE, an RF signal for energy harvesting based on the second message including the indication that the request is granted by the first UE.

Additionally or alternatively, the communications manager 820 may support wireless communications at a first UE in accordance with examples as disclosed herein. In some examples, the request message manager 825 may be configured as or otherwise support a means for receiving, from a second UE, a first message indicating a request for the first UE to charge a battery of the second UE using RF signaling. In some examples, the response message manager 830 may be configured as or otherwise support a means for transmitting, to the second UE, a second message in response to the first message based on a charging probability associated with the request, the second message including an indication that the request is granted by the first UE or an indication that the request is denied by the first UE. The charging probability manager 835 may be configured as or otherwise support a means for updating the charging probability based on the second message. The charging probability transmitter 840 may be configured as or otherwise support a means for transmitting, to one or more additional UEs, a third message indicating the charging probability based on the updating.

In some examples, the charging probability manager 835 may be configured as or otherwise support a means for receiving, from a third UE, a fourth message indicating a second charging probability stored at the third UE and associated with the request. In some examples, the charging probability calculating manager 850 may be configured as or otherwise support a means for calculating the charging probability based on the second charging probability.

In some examples, the charging probability calculating manager 850 may be configured as or otherwise support a means for calculating the charging probability based on a set of statuses corresponding to a set of messages received from the second UE and indicating charging requests, where a status of a respective message of the set of messages indicates whether a charging request of the respective message was granted or denied.

In some examples, the charging probability calculating manager 850 may be configured as or otherwise support a means for calculating the charging probability based on a set of statuses corresponding to a set of messages received from a set of multiple UEs and indicating charging requests, where a status of a respective message of the set of messages indicates whether a charging request of the respective message was granted or denied.

In some examples, the charging probability calculating manager 850 may be configured as or otherwise support a means for calculating the charging probability based on a likelihood of the first UE to grant the request.

In some examples, the charging probability manager 835 may be configured as or otherwise support a means for updating a probability distribution for charging times based on a time duration between receiving the first message and transmitting the second message, where the third message further indicates the probability distribution.

In some examples, the charging probability calculating manager 850 may be configured as or otherwise support a means for calculating the charging probability based on a likelihood of the first UE to grant the request within a time duration.

In some examples, the storage manager 860 may be configured as or otherwise support a means for storing, at the first UE, a first indication of a set of multiple requests for the first UE to charge the battery of the second UE using the RF signaling. In some examples, the storage manager 860 may be configured as or otherwise support a means for storing, at the first UE, a second indication of a set of multiple statuses corresponding to the set of multiple requests, where a status of a respective request of the set of multiple requests indicates whether the respective request was granted or denied by the first UE, where the charging probability is based on the first indication and the second indication.

In some examples, the charging probability may indicate a probability that the first UE will grant the request for the first UE to charge the battery of the second UE. For example, the charging probability may be a percentage or other metric indicating the likelihood that the first UE will transmit RF signaling to the second UE for EH procedures in response to the request.

In some examples, the third message is transmitted according to a periodicity, a schedule, or both. In some examples, the third message is transmitted via broadcast, unicast, or multicast signaling. In some examples, the third message includes a physical shared channel transmission, a sidelink transmission, a MAC-CE, or a combination thereof.

In some examples, the charging probability transmitter 840 may be configured as or otherwise support a means for receiving, from a third UE, a fifth message requesting sharing of the charging probability, where the third message is transmitted in response to the fifth message and the one or more additional UEs includes at least the third UE.

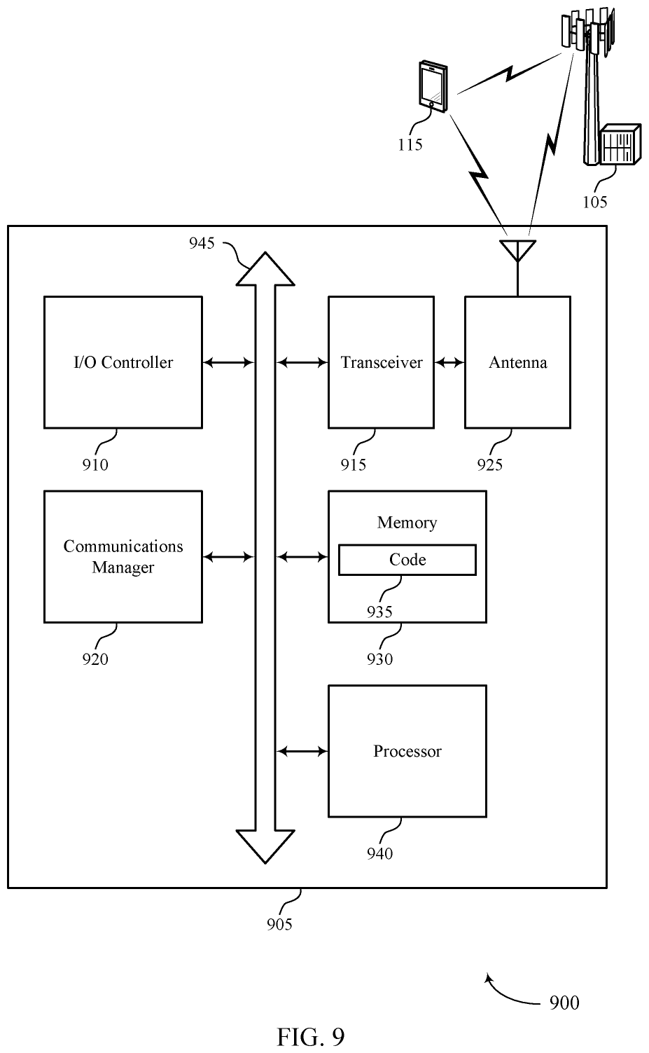

FIG. 9 shows a diagram of a system 900 including a device 905 that supports charging probability sharing and charging UE behavior in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting charging probability sharing and charging UE behavior). For example, the device 905 or a component of the device 905 may include a processor 940 and memory 930 coupled to the processor 940, the processor 940 and memory 930 configured to perform various functions described herein.

The communications manager 920 may support wireless communications at a first UE in accordance with examples as disclosed herein. For example, the communications manager 920 may be configured as or otherwise support a means for receiving, from a second UE, a first message indicating a request for the first UE to charge a battery of the second UE using RF signaling. The communications manager 920 may be configured as or otherwise support a means for transmitting, to the second UE, a second message in response to the first message, the second message including an indication that the request is granted by the first UE or an indication that the request is denied by the first UE based on an available power at the first UE, one or more available power thresholds, a charging probability associated with the request, and a charging probability threshold.

Additionally or alternatively, the communications manager 920 may support wireless communications at a first UE in accordance with examples as disclosed herein. For example, the communications manager 920 may be configured as or otherwise support a means for receiving, from a second UE, a first message indicating a request for the first UE to charge a battery of the second UE using RF signaling. The communications manager 920 may be configured as or otherwise support a means for transmitting, to the second UE, a second message in response to the first message based on a charging probability associated with the request, the second message including an indication that the request is granted by the first UE or an indication that the request is denied by the first UE. The communications manager 920 may be configured as or otherwise support a means for updating the charging probability based on the second message. The communications manager 920 may be configured as or otherwise support a means for transmitting, to one or more additional UEs, a third message indicating the charging probability based on the updating.

By including or configuring the communications manager 920 in accordance with examples as described herein, the device 905 may support techniques for improved EH procedures. For example, the device 905 may support improved logic for responding to a charging request received from an EH device by determining whether to grant or deny the charging request based on charging probability information related to the device 905, the EH device, or one or more other charging devices, which may improve communications and charging efficiency at the device 905. Additionally or alternatively, the device 905 may share charging probability information with other charging devices, thereby improving communications and charging efficiency across an EH network. As charging devices respond to charging request messages with reduced latency, power distribution in the EH network may be improved.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of charging probability sharing and charging UE behavior as described herein, or the processor 940 and the memory 930 may be otherwise configured to perform or support such operations.

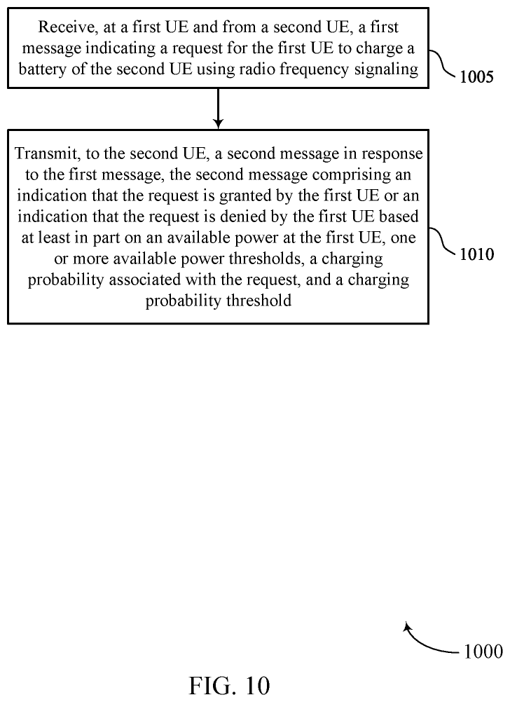

FIG. 10 shows a flowchart illustrating a method 1000 that supports charging probability sharing and charging UE behavior in accordance with aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1005, the method may include receiving, at a first UE and from a second UE, a first message indicating a request for the first UE to charge a battery of the second UE using RF signaling. The operations of 1005 may be performed in accordance with examples as disclosed herein. In some examples, aspects of the operations of 1005 may be performed by a request message manager 825 as described with reference to FIG. 8.

At 1010, the method may include transmitting, to the second UE, a second message in response to the first message, the second message including an indication that the request is granted by the first UE or an indication that the request is denied by the first UE based on an available power at the first UE, one or more available power thresholds, a charging probability associated with the request, and a charging probability threshold. The operations of 1010 may be performed in accordance with examples as disclosed herein. In some examples, aspects of the operations of 1010 may be performed by a response message manager 830 as described with reference to FIG. 8.

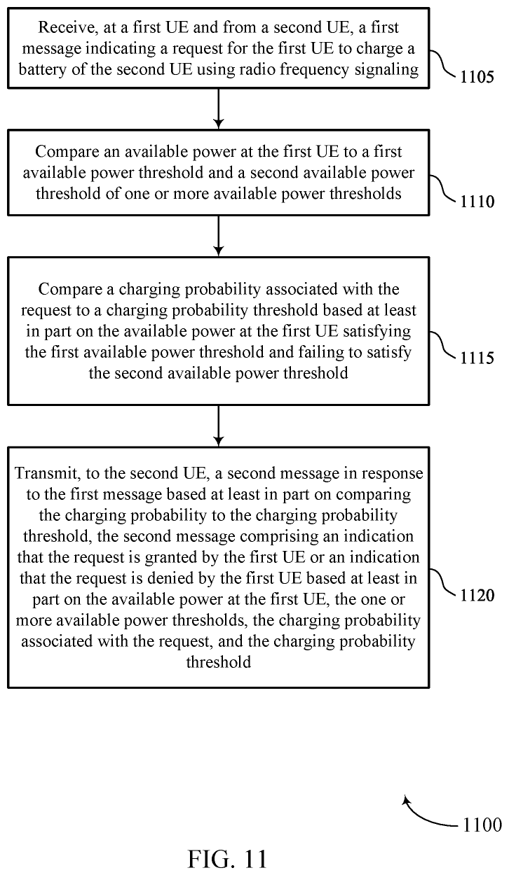

FIG. 11 shows a flowchart illustrating a method 1100 that supports charging probability sharing and charging UE behavior in accordance with aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1105, the method may include receiving, at a first UE and from a second UE, a first message indicating a request for the first UE to charge a battery of the second UE using RF signaling. The operations of 1105 may be performed in accordance with examples as disclosed herein. In some examples, aspects of the operations of 1105 may be performed by a request message manager 825 as described with reference to FIG. 8.

At 1110, the method may include comparing an available power at the first UE to a first available power threshold and a second available power threshold of one or more available power thresholds. The operations of 1110 may be performed in accordance with examples as disclosed herein. In some examples, aspects of the operations of 1110 may be performed by a threshold manager 845 as described with reference to FIG. 8.

At 1115, the method may include comparing a charging probability associated with the request to a charging probability threshold based on the available power at the first UE satisfying the first available power threshold and failing to satisfy the second available power threshold. The operations of 1115 may be performed in accordance with examples as disclosed herein. In some examples, aspects of the operations of 1115 may be performed by a threshold manager 845 as described with reference to FIG. 8.

At 1120, the method may include transmitting, to the second UE, a second message in response to the first message based on comparing the charging probability to the charging probability threshold, the second message including an indication that the request is granted by the first UE or an indication that the request is denied by the first UE based on the available power at the first UE, the one or more available power thresholds, the charging probability associated with the request, and the charging probability threshold. The operations of 1120 may be performed in accordance with examples as disclosed herein. In some examples, aspects of the operations of 1120 may be performed by a response message manager 830 as described with reference to FIG. 8.

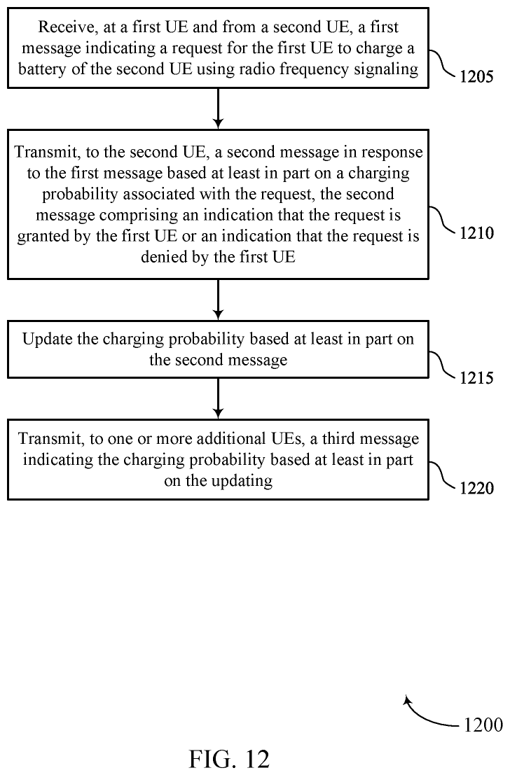

FIG. 12 shows a flowchart illustrating a method 1200 that supports charging probability sharing and charging UE behavior in accordance with aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1205, the method may include receiving, at a first UE and from a second UE, a first message indicating a request for the first UE to charge a battery of the second UE using RF signaling. The operations of 1205 may be performed in accordance with examples as disclosed herein. In some examples, aspects of the operations of 1205 may be performed by a request message manager 825 as described with reference to FIG. 8.

At 1210, the method may include transmitting, to the second UE, a second message in response to the first message based on a charging probability associated with the request, the second message including an indication that the request is granted by the first UE or an indication that the request is denied by the first UE. The operations of 1210 may be performed in accordance with examples as disclosed herein. In some examples, aspects of the operations of 1210 may be performed by a response message manager 830 as described with reference to FIG. 8.

At 1215, the method may include updating the charging probability based on the second message. The operations of 1215 may be performed in accordance with examples as disclosed herein. In some examples, aspects of the operations of 1215 may be performed by a charging probability manager 835 as described with reference to FIG. 8.

At 1220, the method may include transmitting, to one or more additional UEs, a third message indicating the charging probability based on the updating. The operations of 1220 may be performed in accordance with examples as disclosed herein. In some examples, aspects of the operations of 1220 may be performed by a charging probability transmitter 840 as described with reference to FIG. 8.

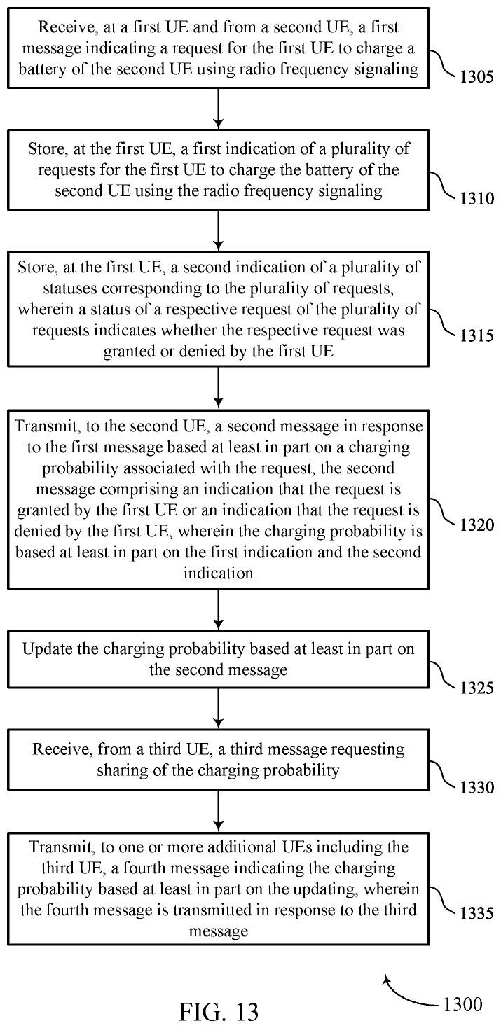

FIG. 13 shows a flowchart illustrating a method 1300 that supports charging probability sharing and charging UE behavior in accordance with aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1305, the method may include receiving, at a first UE and from a second UE, a first message indicating a request for the first UE to charge a battery of the second UE using RF signaling. The operations of 1305 may be performed in accordance with examples as disclosed herein. In some examples, aspects of the operations of 1305 may be performed by a request message manager 825 as described with reference to FIG. 8.

At 1310, the method may include storing, at the first UE, a first indication of a set of multiple requests for the first UE to charge the battery of the second UE using the RF signaling. The operations of 1310 may be performed in accordance with examples as disclosed herein. In some examples, aspects of the operations of 1310 may be performed by a storage manager 860 as described with reference to FIG. 8.

At 1315, the method may include storing, at the first UE, a second indication of a set of multiple statuses corresponding to the set of multiple requests, where a status of a respective request of the set of multiple requests indicates whether the respective request was granted or denied by the first UE. The operations of 1315 may be performed in accordance with examples as disclosed herein. In some examples, aspects of the operations of 1315 may be performed by a storage manager 860 as described with reference to FIG. 8.

At 1320, the method may include transmitting, to the second UE, a second message in response to the first message based on a charging probability associated with the request, the second message including an indication that the request is granted by the first UE or an indication that the request is denied by the first UE, where the charging probability is based on the first indication and the second indication. The operations of 1320 may be performed in accordance with examples as disclosed herein. In some examples, aspects of the operations of 1320 may be performed by a response message manager 830 as described with reference to FIG. 8.

At 1325, the method may include updating the charging probability based on the second message. The operations of 1325 may be performed in accordance with examples as disclosed herein. In some examples, aspects of the operations of 1325 may be performed by a charging probability manager 835 as described with reference to FIG. 8.

At 1330, the method may include receiving, from a third UE, a third message requesting sharing of the charging probability. The operations of 1330 may be performed in accordance with examples as disclosed herein. In some examples, aspects of the operations of 1330 may be performed by a charging probability transmitter 840 as described with reference to FIG. 8.

At 1335, the method may include transmitting, to one or more additional UEs including the third UE, a fourth message indicating the charging probability based on the updating, where the fourth message is transmitted in response to the third message. The operations of 1335 may be performed in accordance with examples as disclosed herein. In some examples, aspects of the operations of 1335 may be performed by a charging probability transmitter 840 as described with reference to FIG. 8.

The following provides an overview of aspects of the present disclosure:

Aspect 1: A method for wireless communications at a first UE, comprising: receiving, from a second UE, a first message indicating a request for the first UE to charge a battery of the second UE using RF signaling; and transmitting, to the second UE, a second message in response to the first message, the second message comprising an indication that the request is granted by the first UE or an indication that the request is denied by the first UE based at least in part on an available power at the first UE, one or more available power thresholds, a charging probability associated with the request, and a charging probability threshold.

Aspect 2: The method of aspect 1, further comprising: comparing the charging probability to the charging probability threshold, wherein transmitting the second message is based at least in part on the comparing.

Aspect 3: The method of aspect 2, further comprising: comparing the available power at the first UE to a first available power threshold and a second available power threshold of the one or more available power thresholds, wherein comparing the charging probability to the charging probability threshold is based at least in part on the available power at the first UE satisfying the first available power threshold and failing to satisfy the second available power threshold.

Aspect 4: The method of any of aspects 2 through 3, wherein the second message comprises the indication that the request is denied by the first UE based at least in part on the charging probability satisfying the charging probability threshold.

Aspect 5: The method of any of aspects 2 through 3, wherein the second message comprises the indication that the request is granted by the first UE based at least in part on the charging probability failing to satisfy the charging probability threshold.

Aspect 6: The method of any of aspects 1 through 2, further comprising: comparing the available power at the first UE to a first available power threshold of the one or more available power thresholds, wherein the second message comprises the indication that the request is denied by the first UE based at least in part on the available power at the first UE failing to satisfy the first available power threshold.

Aspect 7: The method of any of aspects 1 through 2, further comprising: comparing the available power at the first UE to a second available power threshold of the one or more available power thresholds, wherein the second message comprises the indication that the request is granted by the first UE based at least in part on the available power at the first UE satisfying the second available power threshold.

Aspect 8: The method of any of aspects 1 through 7, further comprising: calculating the charging probability based at least in part on a set of statuses corresponding to a set of messages received from the second UE and indicating charging requests, wherein a status of a respective message of the set of messages indicates whether a charging request of the respective message was granted or denied.

Aspect 9: The method of any of aspects 1 through 8, further comprising: calculating the charging probability based at least in part on a set of statuses corresponding to a set of messages received from a plurality of UEs and indicating charging requests, wherein a status of a respective message of the set of messages indicates whether a charging request of the respective message was granted or denied.

Aspect 10: The method of any of aspects 1 through 9, further comprising: calculating the charging probability based at least in part on a likelihood of the first UE to grant the request.

Aspect 11: The method of any of aspects 1 through 10, further comprising: updating the charging probability based at least in part on the second message.

Aspect 12: The method of any of aspects 1 through 11, further comprising: transmitting a third message indicating the charging probability.

Aspect 13: The method of any of aspects 1 through 12, further comprising: receiving, from a third UE, a fourth message indicating a second charging probability stored at the third UE and associated with the request; and calculating the charging probability based at least in part on the second charging probability.

Aspect 14: The method of any of aspects 1 through 13, wherein the charging probability indicates a probability that the first UE will grant the request for the first UE to charge the battery of the second UE.

Aspect 15: The method of any of aspects 1 through 14, further comprising: receiving control signaling configuring the one or more thresholds.

Aspect 16: The method of aspect 15, wherein the control signaling is received from a network entity and the control signaling comprises RRC signaling.

Aspect 17: The method of any of aspects 1 through 16, further comprising: transmitting, to the second UE, an RF signal for EH based at least in part on the second message comprising the indication that the request is granted by the first UE.

Aspect 18: A method for wireless communications at a first UE, comprising: receiving, from a second UE, a first message indicating a request for the first UE to charge a battery of the second UE using RF signaling; transmitting, to the second UE, a second message in response to the first message based at least in part on a charging probability associated with the request, the second message comprising an indication that the request is granted by the first UE or an indication that the request is denied by the first UE; updating the charging probability based at least in part on the second message; and transmitting, to one or more additional UEs, a third message indicating the charging probability based at least in part on the updating.

Aspect 19: The method of aspect 18, further comprising: receiving, from a third UE, a fourth message indicating a second charging probability stored at the third UE and associated with the request; and calculating the charging probability based at least in part on the second charging probability.

Aspect 20: The method of any of aspects 18 through 19, further comprising: calculating the charging probability based at least in part on a set of statuses corresponding to a set of messages received from the second UE and indicating charging requests, wherein a status of a respective message of the set of messages indicates whether a charging request of the respective message was granted or denied.

Aspect 21: The method of any of aspects 18 through 20, further comprising: calculating the charging probability based at least in part on a set of statuses corresponding to a set of messages received from a plurality of UEs and indicating charging requests, wherein a status of a respective message of the set of messages indicates whether a charging request of the respective message was granted or denied.

Aspect 22: The method of any of aspects 18 through 21, further comprising: calculating the charging probability based at least in part on a likelihood of the first UE to grant the request.

Aspect 23: The method of any of aspects 18 through 22, further comprising: updating a probability distribution for charging times based at least in part on a time duration between receiving the first message and transmitting the second message, wherein the third message further indicates the probability distribution.

Aspect 24: The method of any of aspects 18 through 23, further comprising: calculating the charging probability based at least in part on a likelihood of the first UE to grant the request within a time duration.

Aspect 25: The method of any of aspects 18 through 24, further comprising: storing, at the first UE, a first indication of a plurality of requests for the first UE to charge the battery of the second UE using the RF signaling; and storing, at the first UE, a second indication of a plurality of statuses corresponding to the plurality of requests, wherein a status of a respective request of the plurality of requests indicates whether the respective request was granted or denied by the first UE, wherein the charging probability is based at least in part on the first indication and the second indication.

Aspect 26: The method of any of aspects 18 through 25, wherein the charging probability indicates a probability that the first UE will grant the request for the first UE to charge the battery of the second UE.

Aspect 27: The method of any of aspects 18 through 26, wherein the third message is transmitted according to a periodicity, a schedule, or both.

Aspect 28: The method of any of aspects 18 through 27, further comprising: receiving, from a third UE, a fifth message requesting sharing of the charging probability, wherein the third message is transmitted in response to the fifth message and the one or more additional UEs comprises at least the third UE.

Aspect 29: The method of any of aspects 18 through 28, wherein the third message is transmitted via broadcast, unicast, or multicast signaling.

Aspect 30: The method of any of aspects 18 through 29, wherein the third message comprises a physical shared channel transmission, a sidelink transmission, a MAC-CE, or a combination thereof.

Aspect 31: An apparatus for wireless communications at a first UE, comprising: a memory; and a processor coupled with the memory and configured to cause the apparatus to perform a method of any of aspects 1 through 17.

Aspect 32: An apparatus for wireless communications at a first UE, comprising at least one means for performing a method of any of aspects 1 through 17.

Aspect 33: A non-transitory computer-readable medium storing code for wireless communications at a first UE, the code comprising instructions executable by a processor to perform a method of any of aspects 1 through 17.

Aspect 34: An apparatus for wireless communications at a first UE, comprising: a memory; and a processor coupled with the memory and configured to cause the apparatus to perform a method of any of aspects 18 through 30.

Aspect 35: An apparatus for wireless communications at a first UE, comprising at least one means for performing a method of any of aspects 18 through 30.

Aspect 36: A non-transitory computer-readable medium storing code for wireless communications at a first UE, the code comprising instructions executable by a processor to perform a method of any of aspects 18 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a first user equipment (UE), comprising:
a memory; and
a processor coupled with the memory and configured to cause the apparatus to:
receive, from a second UE, a first message indicating a request for the first UE to charge a battery of the second UE using radio frequency signaling; and
transmit, to the second UE, a second message in response to the first message, the second message comprising an indication that the request is granted by the first UE or an indication that the request is denied by the first UE based at least in part on an available power at the first UE, one or more available power thresholds, a charging probability associated with the request, and a charging probability threshold.

2. The apparatus of claim 1, wherein the processor is further configured to cause the apparatus to:
compare the charging probability to the charging probability threshold, wherein transmitting the second message is based at least in part on the comparing.

3. The apparatus of claim 2, wherein the processor is further configured to cause the apparatus to:
compare the available power at the first UE to a first available power threshold and a second available power threshold of the one or more available power thresholds, wherein comparing the charging probability to the charging probability threshold is based at least in part on the available power at the first UE satisfying the first available power threshold and failing to satisfy the second available power threshold.

4. The apparatus of claim 2, wherein the second message comprises the indication that the request is denied by the first UE based at least in part on the charging probability satisfying the charging probability threshold.

5. The apparatus of claim 2, wherein the second message comprises the indication that the request is granted by the first UE based at least in part on the charging probability failing to satisfy the charging probability threshold.

6. The apparatus of claim 1, wherein the processor is further configured to cause the apparatus to:
compare the available power at the first UE to a first available power threshold of the one or more available power thresholds, wherein the second message comprises the indication that the request is denied by the first UE based at least in part on the available power at the first UE failing to satisfy the first available power threshold.

7. The apparatus of claim 1, wherein the processor is further configured to cause the apparatus to:
compare the available power at the first UE to a second available power threshold of the one or more available power thresholds, wherein the second message comprises the indication that the request is granted by the first UE based at least in part on the available power at the first UE satisfying the second available power threshold.

8. The apparatus of claim 1, wherein the processor is further configured to cause the apparatus to:
calculate the charging probability based at least in part on a set of statuses corresponding to a set of messages received from the second UE and indicating charging requests, wherein a status of a respective message of the set of messages indicates whether a charging request of the respective message was granted or denied.

9. The apparatus of claim 1, wherein the processor is further configured to cause the apparatus to:
calculate the charging probability based at least in part on a set of statuses corresponding to a set of messages received from a plurality of UEs and indicating charging requests, wherein a status of a respective message of the set of messages indicates whether a charging request of the respective message was granted or denied.

10. The apparatus of claim 1, wherein the processor is further configured to cause the apparatus to:
calculate the charging probability based at least in part on a likelihood of the first UE to grant the request.

11. The apparatus of claim 1, wherein the processor is further configured to cause the apparatus to:
update the charging probability based at least in part on the second message.

12. The apparatus of claim 1, wherein the processor is further configured to cause the apparatus to:
transmit a third message indicating the charging probability.

13. The apparatus of claim 1, wherein the processor is further configured to cause the apparatus to:
receive, from a third UE, a fourth message indicating a second charging probability stored at the third UE and associated with the request; and
calculate the charging probability based at least in part on the second charging probability.

14. The apparatus of claim 1, wherein the charging probability indicates a probability that the first UE will grant the request for the first UE to charge the battery of the second UE.

15. The apparatus of claim 1, wherein the processor is further configured to cause the apparatus to:
receive control signaling configuring the one or more available power thresholds, the charging probability threshold, or a combination thereof.

16. The apparatus of claim 15, wherein the control signaling is received from a network entity and the control signaling comprises radio resource control signaling.

17. The apparatus of claim 1, wherein the processor is further configured to cause the apparatus to:
transmit, to the second UE, a radio frequency signal for energy harvesting based at least in part on the second message comprising the indication that the request is granted by the first UE.

18. An apparatus for wireless communications at a first user equipment (UE), comprising:
a memory; and
a processor coupled with the memory and configured to cause the apparatus to:
receive, from a second UE, a first message indicating a request for the first UE to charge a battery of the second UE using radio frequency signaling;
transmit, to the second UE, a second message in response to the first message based at least in part on a charging probability associated with the request, the second message comprising an indication that the request is granted by the first UE or an indication that the request is denied by the first UE;
update the charging probability based at least in part on the second message; and
transmit, to one or more additional UEs, a third message indicating the charging probability based at least in part on the updating.

19. The apparatus of claim 18, wherein the processor is further configured to cause the apparatus to:
receive, from a third UE, a fourth message indicating a second charging probability stored at the third UE and associated with the request; and
calculate the charging probability based at least in part on the second charging probability.

20. The apparatus of claim 18, wherein the processor is further configured to cause the apparatus to:
calculate the charging probability based at least in part on a set of statuses corresponding to a set of messages received from the second UE and indicating charging requests, wherein a status of a respective message of the set of messages indicates whether a charging request of the respective message was granted or denied.

21. The apparatus of claim 18, wherein the processor is further configured to cause the apparatus to:
calculate the charging probability based at least in part on a set of statuses corresponding to a set of messages received from a plurality of UEs and indicating charging requests, wherein a status of a respective message of the set of messages indicates whether a charging request of the respective message was granted or denied.

22. The apparatus of claim 18, wherein the processor is further configured to cause the apparatus to:
calculate the charging probability based at least in part on a likelihood of the first UE to grant the request.

23. The apparatus of claim 18, wherein the processor is further configured to cause the apparatus to:
update a probability distribution for charging times based at least in part on a time duration between receiving the first message and transmitting the second message, wherein the third message further indicates the probability distribution.

24. The apparatus of claim 18, wherein the processor is further configured to cause the apparatus to:
calculate the charging probability based at least in part on a likelihood of the first UE to grant the request within a time duration.

25. The apparatus of claim 18, wherein the processor is further configured to cause the apparatus to:
store, at the first UE, a first indication of a plurality of requests for the first UE to charge the battery of the second UE using the radio frequency signaling; and
store, at the first UE, a second indication of a plurality of statuses corresponding to the plurality of requests, wherein a status of a respective request of the plurality of requests indicates whether the respective request was granted or denied by the first UE, wherein the charging probability is based at least in part on the first indication and the second indication.

26. The apparatus of claim 18, wherein the charging probability indicates a probability that the first UE will grant the request for the first UE to charge the battery of the second UE.

27. The apparatus of claim 18, wherein the third message is transmitted according to a periodicity, a schedule, or both.

28. The apparatus of claim 18, wherein the processor is further configured to cause the apparatus to:
receive, from a third UE, a fifth message requesting sharing of the charging probability, wherein the third message is transmitted in response to the fifth message and the one or more additional UEs comprises at least the third UE.

29. The apparatus of claim 18, wherein the third message is transmitted via broadcast, unicast, or multicast signaling.

30. The apparatus of claim 18, wherein the third message comprises a physical shared channel transmission, a sidelink transmission, a medium access control (MAC) control element (CE), or a combination thereof.

31. A method for wireless communications at a first user equipment (UE), comprising:
receiving, from a second UE, a first message indicating a request for the first UE to charge a battery of the second UE using radio frequency signaling; and
transmitting, to the second UE, a second message in response to the first message, the second message comprising an indication that the request is granted by the first UE or an indication that the request is denied by the first UE based at least in part on an available power at the first UE, one or more available power thresholds, a charging probability associated with the request, and a charging probability threshold.

32. A method for wireless communications at a first user equipment (UE), comprising:
receiving, from a second UE, a first message indicating a request for the first UE to charge a battery of the second UE using radio frequency signaling;
transmitting, to the second UE, a second message in response to the first message based at least in part on a charging probability associated with the request, the second message comprising an indication that the request is granted by the first UE or an indication that the request is denied by the first UE;
updating the charging probability based at least in part on the second message; and
transmitting, to one or more additional UEs, a third message indicating the charging probability based at least in part on the updating.
